(19) United States
(12) Patent Application Publication
(10) Pub. No.: US 2024/0357376 A1
(43) Pub. Date: Oct. 24, 2024

(54) ADAPTATION INDICATION

(71) Applicant: QUALCOMM Incorporated, San Diego, CA (US)

(72) Inventors: Jianghong LUO, Skillman, NJ (US); Hung Dinh LY, San Diego, CA (US)

(21) Appl. No.: 18/635,418

(22) Filed: Apr. 15, 2024

Related U.S. Application Data
(60) Provisional application No. 63/496,824, filed on Apr. 18, 2023.

(51) Int. Cl. H04W 16/28; H04B 7/06; H04W 8/22; H04W 72/1273

(52) U.S. Cl. CPC H04W 16/28; H04B 7/0626; H04B 7/0639; H04W 8/22; H04W 72/1273

(57) ABSTRACT

Various aspects of the present disclosure generally relate to wireless communication. In some aspects, a user equipment (UE) may receive an adaptation indication that includes a spatial adaptation indication that indicates one or more derived resources associated with a first CSI-RS base resource, each derived resource including a subset of channel state information (CSI) reference signal (CSI-RS) ports of a network entity that are derived from the first CSI-RS base resource, and/or a power adaptation indication that indicates power offsets for the first CSI-RS base resource or for the derived resources. The UE may transmit CSI feedback based at least in part on measurement of a CSI-RS from the derived resources, measurement of the CSI-RS in association with the power offsets, and/or measurement of a base CSI-RS transmitted from the first CSI-RS base resource in association with the power offsets. Numerous other aspects are described.

### CROSS-REFERENCE TO RELATED APPLICATION

This patent application claims priority to U.S. Provisional Patent Application No. 63/496,824, filed on Apr. 18, 2023, entitled “ADAPTATION INDICATION,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for using an adaptation indication for derived resources of ports or for power control offsets.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving an adaptation indication that includes one or more of: a spatial adaptation indication that indicates one or more derived resources associated with a first channel state information (CSI) reference signal (CSI-RS) base resource, each derived resource including a subset of CSI-RS ports of a network entity that are derived from the first CSI-RS base resource, or a power adaptation indication that indicates one or more power offsets for the first CSI-RS base resource or for the one or more derived resources. The method may include transmitting CSI feedback based at least in part on one or more of measurement of a CSI-RS from the one or more derived resources, measurement of the CSI-RS in association with the one or more power offsets, or measurement of a base CSI-RS transmitted from the first CSI-RS base resource in association with the one or more power offsets.

Some aspects described herein relate to a method of wireless communication performed by a network entity. The method may include generating an adaptation indication that includes one or more of: a spatial adaptation indication that indicates one or more derived resources associated with a first CSI-RS base resource, each derived resource including a subset of CSI-RS ports of a network entity that are derived from the first CSI-RS base resource, or a power adaptation indication that indicates one or more power offsets for the first CSI-RS base resource or for the one or more derived resources. The method may include transmitting the adaptation indication.

Some aspects described herein relate to a UE for wireless communication. The UE may include a memory and one or more processors coupled to the memory. The one or more processors may be configured to receive an adaptation indication that includes one or more of: a spatial adaptation indication that indicates one or more derived resources associated with a first CSI-RS base resource, each derived resource including a subset of CSI-RS ports of a network entity that are derived from the first CSI-RS base resource, or a power adaptation indication that indicates one or more power offsets for the first CSI-RS base resource or for the one or more derived resources. The one or more processors may be configured to transmit CSI feedback based at least in part on one or more of measurement of a CSI-RS from the one or more derived resources, measurement of the CSI-RS in association with the one or more power offsets, or measurement of a base CSI-RS transmitted from the first CSI-RS base resource in association with the one or more power offsets.

Some aspects described herein relate to a network entity for wireless communication. The network entity may include a memory and one or more processors coupled to the memory. The one or more processors may be configured to generate an adaptation indication that includes one or more of: a spatial adaptation indication that indicates one or more derived resources associated with a first CSI-RS base resource, each derived resource including a subset of CSI-RS ports of a network entity that are derived from the first CSI-RS base resource, or a power adaptation indication that indicates one or more power offsets for the first CSI-RS base resource or for the one or more derived resources. The one or more processors may be configured to transmit the adaptation indication.

Some aspects described herein relate to a non-transitory computer-readable medium that stores a set of instructions for wireless communication by a UE. The set of instructions, when executed by one or more processors of the UE, may cause the UE to receive an adaptation indication that includes one or more of: a spatial adaptation indication that indicates one or more derived resources associated with a first CSI-RS base resource, each derived resource including a subset of CSI-RS ports of a network entity that are derived from the first CSI-RS base resource, or a power adaptation indication that indicates one or more power offsets for the first CSI-RS base resource or for the one or more derived resources. The set of instructions, when executed by one or more processors of the UE, may cause the UE to transmit CSI feedback based at least in part on one or more of measurement of a CSI-RS from the one or more derived resources, measurement of the CSI-RS in association with the one or more power offsets, or measurement of a base CSI-RS transmitted from the first CSI-RS base resource in association with the one or more power offsets.

Some aspects described herein relate to a non-transitory computer-readable medium that stores a set of instructions for wireless communication by a network entity. The set of instructions, when executed by one or more processors of the network entity, may cause the network entity to generate an adaptation indication that includes one or more of: a spatial adaptation indication that indicates one or more derived resources associated with a first CSI-RS base resource, each derived resource including a subset of CSI-RS ports of a network entity that are derived from the first CSI-RS base resource, or a power adaptation indication that indicates one or more power offsets for the first CSI-RS base resource or for the one or more derived resources. The set of instructions, when executed by one or more processors of the network entity, may cause the network entity to transmit the adaptation indication.

Some aspects described herein relate to an apparatus for wireless communication. The apparatus may include means for receiving an adaptation indication that includes one or more of: a spatial adaptation indication that indicates one or more derived resources associated with a first CSI-RS base resource, each derived resource including a subset of CSI-RS ports of a network entity that are derived from the first CSI-RS base resource, or a power adaptation indication that indicates one or more power offsets for the first CSI-RS base resource or for the one or more derived resources. The apparatus may include means for transmitting CSI feedback based at least in part on one or more of measurement of a CSI-RS from the one or more derived resources, measurement of the CSI-RS in association with the one or more power offsets, or measurement of a base CSI-RS transmitted from the first CSI-RS base resource in association with the one or more power offsets.

Some aspects described herein relate to an apparatus for wireless communication. The apparatus may include means for generating an adaptation indication that includes one or more of: a spatial adaptation indication that indicates one or more derived resources associated with a first CSI-RS base resource, each derived resource including a subset of CSI-RS ports of a network entity that are derived from the first CSI-RS base resource, or a power adaptation indication that indicates one or more power offsets for the first CSI-RS base resource or for the one or more derived resources. The apparatus may include means for transmitting the adaptation indication.

Aspects generally include a method, apparatus, system, computer program product, non-transitory computer-readable medium, UE, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of channel state information (CSI) reference signal (CSI-RS) beam management procedures, in accordance with the present disclosure.

FIG. 5 is a diagram illustrating an example of a CSI report configuration, in accordance with the present disclosure.

FIG. 6 is a diagram illustrating an example of computing CSI processing parameters, in accordance with the present disclosure.

FIG. 7 is a diagram illustrating an example of spatial adaptation, in accordance with the present disclosure.

FIG. 8 is a diagram illustrating an example of an antenna subarray pattern from a CSI-RS resource, in accordance with the present disclosure.

FIG. 9 is a diagram illustrating an example of antenna subarray patterns from a CSI-RS resource, in accordance with the present disclosure.

FIG. 10 is a diagram illustrating an example of derived resources, in accordance with the present disclosure.

FIG. 11 is a diagram illustrating an example of derived resources, in accordance with the present disclosure.

FIG. 12 is a diagram illustrating an example of derived resources, in accordance with the present disclosure.

FIG. 13 is a diagram illustrating an example of CSI report configurations, in accordance with the present disclosure.

FIG. 14 is a diagram illustrating an example of derived resources, in accordance with the present disclosure.

FIG. 15 is a diagram of an example associated with indicating an antenna subarray, in accordance with the present disclosure.

FIG. 16 is a diagram illustrating an example process performed, for example, by a UE, in accordance with the present disclosure.

FIG. 17 is a diagram illustrating an example process performed, for example, by a network entity, in accordance with the present disclosure.

FIG. 18 is a diagram of an example apparatus for wireless communication, in accordance with the present disclosure.

FIG. 19 is a diagram of an example apparatus for wireless communication, in accordance with the present disclosure.

### DETAILED DESCRIPTION

A user equipment (UE) may measure channel state information (CSI) reference signals (CSI-RSs) and provide CSI feedback to a network entity for beam management and communication scheduling. The CSI-RSs may be part of a CSI-RS resource that is associated with a two-dimensional antenna array. A network entity (e.g., gNB) may transmit a CSI-RS signal associated with a full antenna array, and the UE may generate multiple CSIs for different antenna subarrays using the same received CSI-RS signal. Each subarray is associated with a subset of CSI-RS ports and the corresponding subset of time/frequency/code resources of the CSI-RS signal. The different subarrays are used by the UE for the purpose of CSI calculation.

Spatial adaptation at a network entity may include deactivating one or more antenna panels (spatial elements, ports) such that fewer antenna panels are active. Power control offsets may also be used to adapt a transmit power for CSI-RSs. However, there may be a lot of signaling overhead involved with supporting different spatial adaptations or different power control values. Different CSI report configurations may involve different antenna subarray sizes and beam restrictions. One CSI report configuration can support only one codebook configuration and only one spatial pattern. Associated CSI-RS resources in a CSI report configuration are restricted to the same quantity of CSI-RS ports as in the codebook. Power control offsets are configured per CSI-RS resource, and the signaling for power control offsets scales with the quantity of power control values.

Various aspects relate generally to CSI feedback. Some aspects more specifically relate to a UE receiving an adaptation indication that includes a spatial adaptation indication and/or a power adaptation indication. In some examples, the spatial adaptation may indicate one or more derived resources associated with a first CSI-RS base resource, where each derived resource including a subset of CSI-RS ports of a network entity that are derived from the first CSI-RS base resource. In some examples, the power adaptation indication may indicate one or more power offsets for the one or more derived resources or for the first CSI-RS base resource. The UE may transmit CSI feedback based at least in part on measurement of a CSI-RS from the one or more derived resources, measurement of the one or more derived resources in association with the one or more power offsets, and/or measurement of a base CSI-RS transmitted from the first CSI-RS base resource in association with the power offsets. The power offsets may not be used for transmission. Rather, the power offset may be used as assumed or hypothetical power offsets for CSI calculation.

Particular aspects of the subject matter described in this disclosure can be implemented to realize one or more of the following potential advantages. In some examples, by receiving an adaptation indication, the UE may reduce the signaling overhead and conserve signaling resources.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

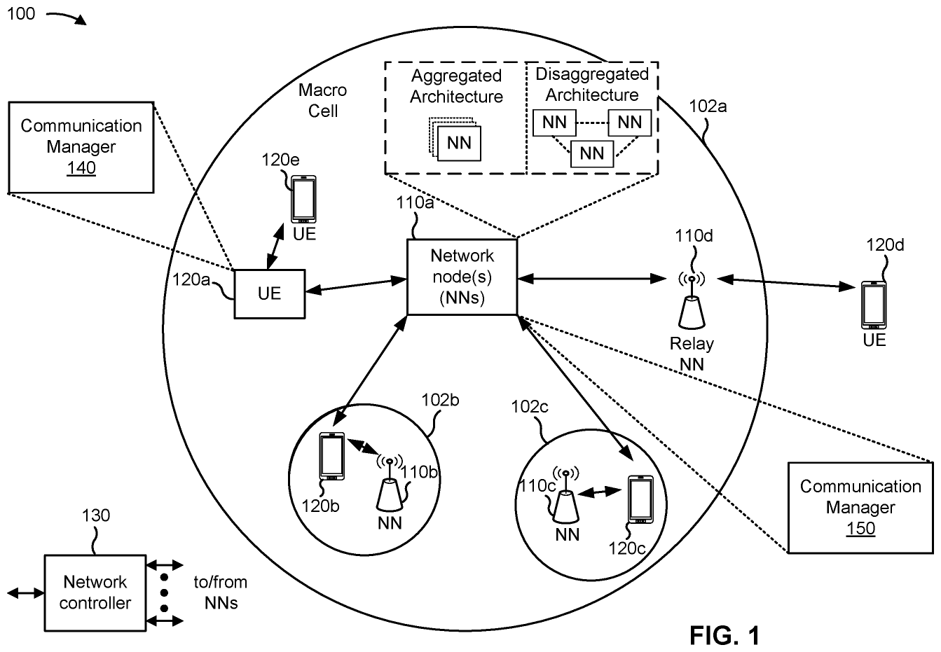

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., a UE 120) may include a communication manager 140. As described in more detail elsewhere herein, the communication manager 140 may receive an adaptation indication that includes one or more of: a spatial adaptation indication that indicates one or more derived resources associated with a first CSI-RS base resource, each derived resource including a subset of CSI-RS ports of a network entity that are derived from the first CSI-RS base resource, or a power adaptation indication that indicates one or more power offsets for the first CSI-RS base resource or for the one or more derived resources. The communication manager 140 may transmit CSI feedback based at least in part on measurement of a CSI-RS from the one or more derived resources or measurement of a base CSI-RS transmitted from the first CSI-RS base resource with the power offset. Additionally, or alternatively, the communication manager 140 may perform one or more other operations described herein.

In some aspects, a network entity (e.g., a network node 110) may include a communication manager 150. As described in more detail elsewhere herein, the communication manager 150 may generate an adaptation indication that includes one or more of: a spatial adaptation indication that indicates one or more derived resources associated with a first CSI-RS base resource, each derived resource including a subset of CSI-RS ports of a network entity that are derived from the first CSI-RS base resource, or a power adaptation indication that indicates one or more power offsets for the first CSI-RS base resource or for the one or more derived resources. The communication manager 150 may transmit the adaptation indication. Additionally, or alternatively, the communication manager 150 may perform one or more other operations described herein.

As indicated above, FIG. 1 is provided as an example. Other examples may differ from what is described with regard to FIG. 1.

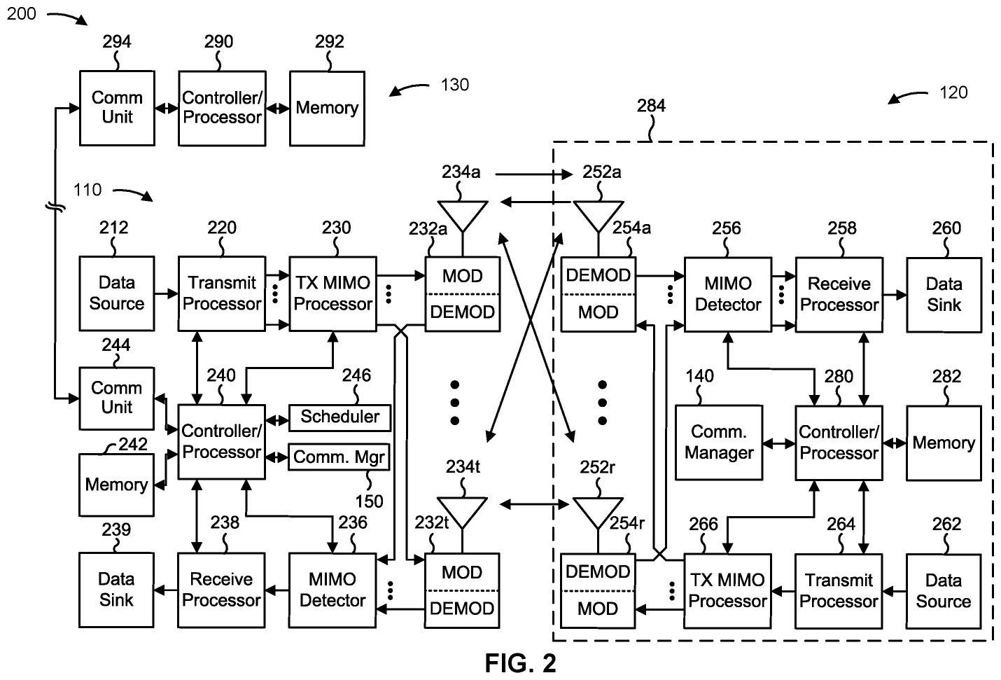

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and May provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

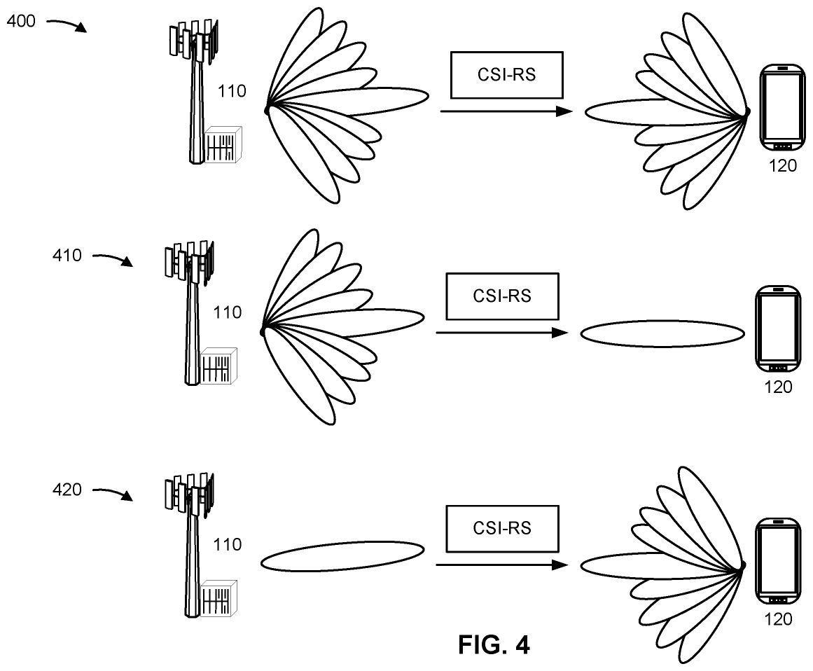

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-19).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-19).

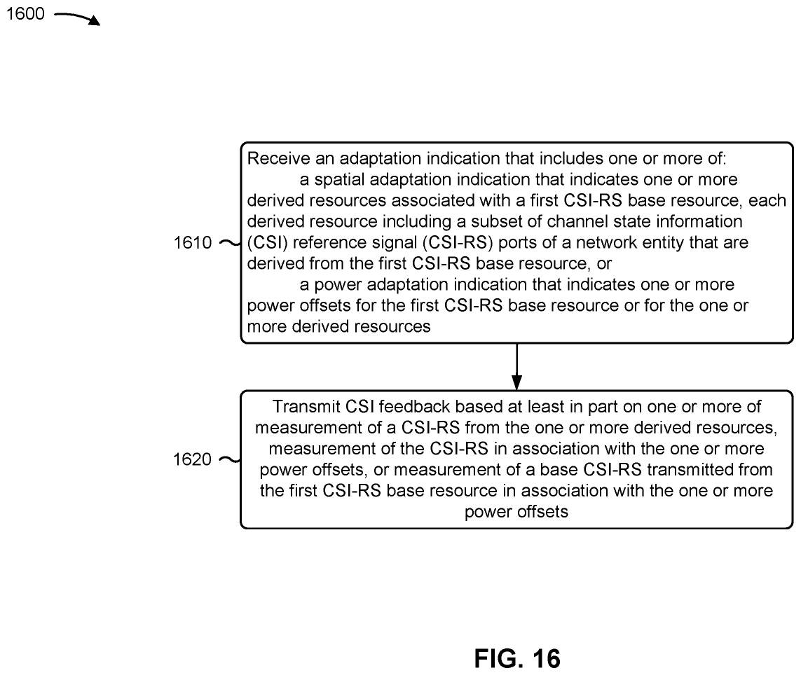

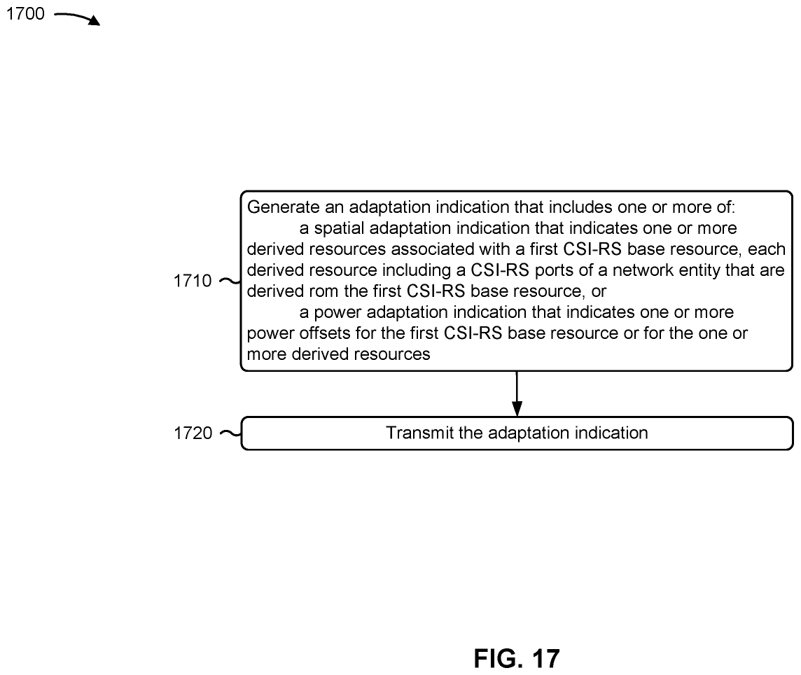

A controller/processor of a network entity (e.g., controller/processor 240 of the network node 110), the controller/processor 280 of the UE 120, and/or any other component(s) of FIG. 2 may perform one or more techniques associated with indicating derived resources for CSI feedback, as described in more detail elsewhere herein. For example, the controller/processor 240 of the network node 110, the controller/processor 280 of the UE 120, and/or any other component(s) of FIG. 2 may perform or direct operations of, for example, process 1600 of FIG. 16, process 1700 of FIG. 17, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1600 of FIG. 16, process 1700 of FIG. 17, and/or other processes as described herein. In some examples, executing instructions may include running the instructions, converting the instructions, compiling the instructions, and/or interpreting the instructions, among other examples.

In some aspects, a UE (e.g., a UE 120) includes means for receiving an adaptation indication that includes one or more of: a spatial adaptation indication that indicates one or more derived resources associated with a first CSI-RS base resource, each derived resource including a subset of CSI-RS ports of a network entity that are derived from the first CSI-RS base resource, or a power adaptation indication that indicates one or more power offsets for the first CSI-RS base resource or for the one or more derived resources; and/or transmitting CSI feedback based at least in part on measurement of a CSI-RS from the one or more derived resources or measurement of a base CSI-RS transmitted from the first CSI-RS base resource with the power offset. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., a network node 110) includes means for generating an adaptation indication that includes one or more of: a spatial adaptation indication that indicates one or more derived resources associated with a first CSI-RS base resource, each derived resource including a subset of CSI-RS ports of a network entity that are derived from the first CSI-RS base resource, or a power adaptation indication that indicates a power adaptation indication that indicates one or more power offsets for the first CSI-RS base resource or for the one or more derived resources; and/or means for transmitting the adaptation indication. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

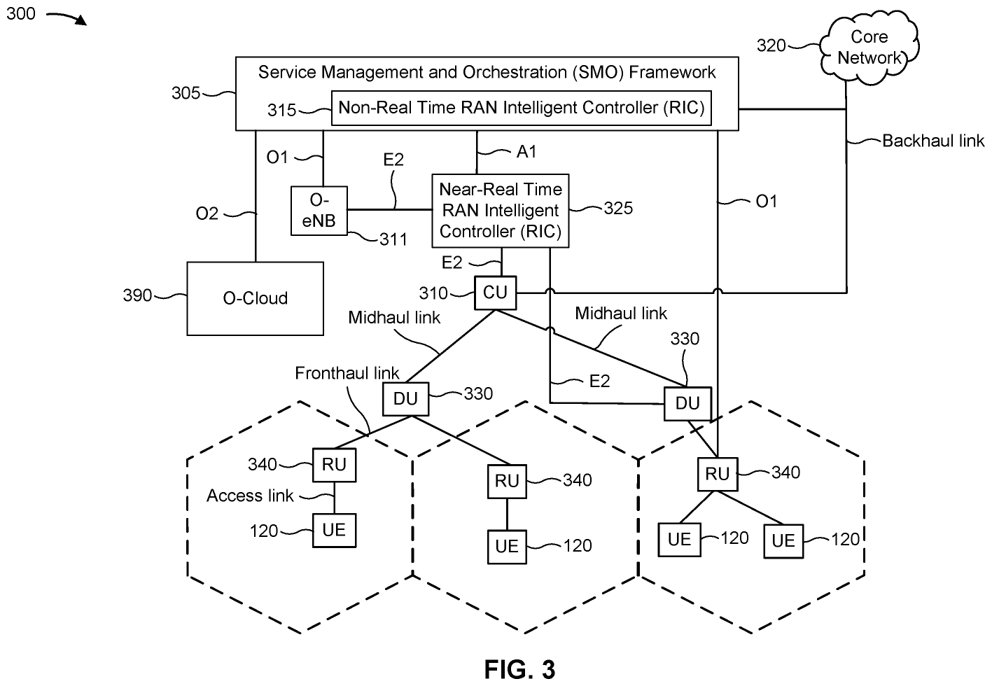

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating examples 400, 410, and 420 of CSI-RS beam management procedures, in accordance with the present disclosure. As shown in FIG. 4, examples 400, 410, and 420 include a UE 120 in communication with a network node 110 in a wireless network (e.g., wireless network 100). However, the devices shown in FIG. 4 are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some aspects, the UE 120 and the network node 110 may be in a connected state (e.g., an RRC connected state).

As shown in FIG. 4, example 400 may include a network node 110 (e.g., one or more network node devices such as an RU, a DU, and/or a CU, among other examples) and a UE 120 communicating to perform beam management using CSI-RSs. Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using MAC control element (MAC CE) signaling), and/or aperiodic (e.g., using downlink control information (DCI)).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same reference signal (RS) resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use synchronization signal blocks (SSBs) for beam management in a similar manner as described above.

As shown in FIG. 4, example 410 may include a network node 110 and a UE 120 communicating to perform beam management using CSI-RSs. Example 410 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE transmit beam.

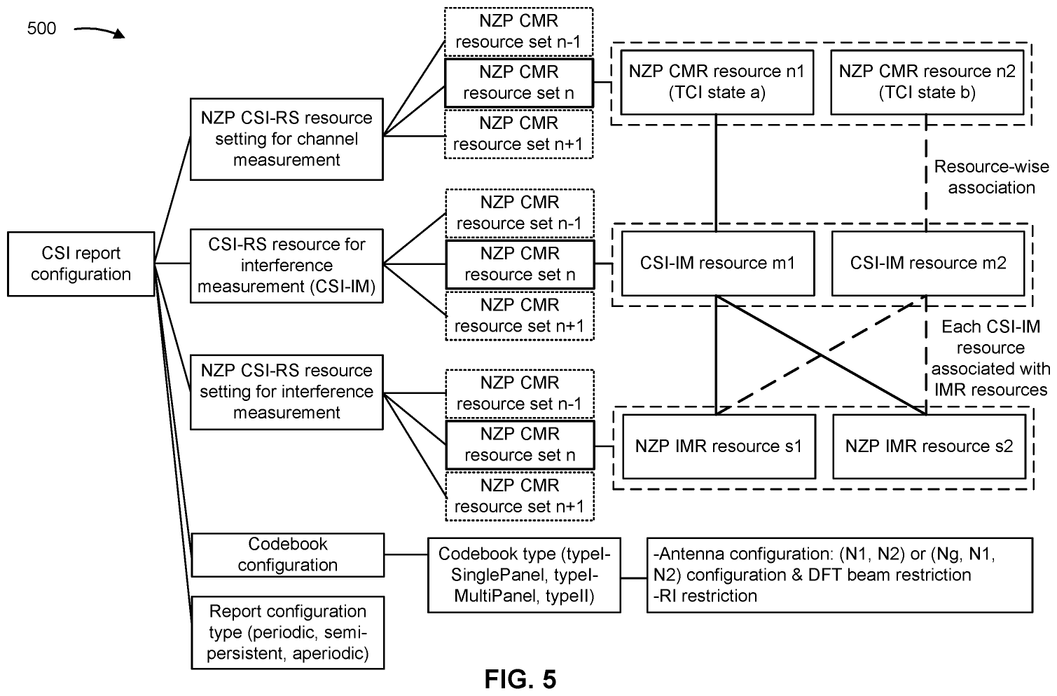

FIG. 5 is a diagram illustrating an example 500 of a CSI report configuration, in accordance with the present disclosure.

A CSI report configuration may be configured per bandwidth part (BWP). A resource set has Ks resources with the same quantity of CSI-RS ports. If Ks=1, each resource may contain at most 32 CSI-RS ports. If Ks=2, each resource may contain at most 16 CSI-RS ports. For Ks=2 to 8, each resource may contain at most 8 CSI-RS ports. A P-port resource has ports labeled from 3000 to 3000 (P−1).

Example 500 shows a CSI report configuration, which may include a CSI resource setting for a channel measurement resource (CMR), a CSI resource setting for CMR and CSI interference measurement (CSI-IM) or non-zero power (NZP) interference measurement resource (IMR), and a CSI resource setting for CMR and CSI-IM and NZP-IMR. Each resource setting may have one active resource set, and each resource set may have one or more resources (N resources). A UE may evaluate CSI corresponding to the N NZP CMR resources and select 1 (one) CMR resource out of N resources. The UE may report a CSI-RS resource indicator (CRI) as part of CSI feedback. The network entity (e.g., gNB) may need to determine a reported CSI that corresponds to an NZP CMR resource. The CSI report configuration may also be referred to as a “CSI report setting.” As described herein, a first CSI report setting may be associated with a second CSI report setting for linking reporting occasions in slots for transmission of CSI reports.

The CSI report configuration may include a codebook configuration that includes a codebook type, such as Type I single panel, Type I multi-panel, Type II single panel, Type II port selection, or Type II enhanced port selection. A codebook type may have an antenna configuration of Ng panels with dimensions N1 and N2. The codebook type may be associated with a DFT beam restriction. The codebook type may have a rank indicator (RI) restriction, or a limit on the quantity of layers. The CSI report configuration may be of a report configuration type (e.g., periodic, semi-persistent, aperiodic).

A UE may use a same set of CSI-RS resources for CSI measurements for different adaptation configurations. In some aspects, the UE may derive CSI for reduced antenna port configurations from a CSI-RS resource with a higher quantity of reports. The UE may transmit supplemental CSI (S-CSI) that is associated with reduced antenna configurations. S-CSI may be derived from the resources configured for the base antenna configuration. The UE may be configured with restriction rules on CSI-RS resources and a codebook for the reduced antenna configuration.

In an example, a CSI report configuration 0 (zero) may include a resource setting and a codebook configuration. A full antenna configuration may include a 32-port CSI-RS resource and a codebook configuration where N1=4 and N2=4. A CSI measurement and report for a reduced antenna configuration may include, for example, a 4-port CSI-RS with N1=2 and N2=1, an 8-port CSI-RS with N1=2 and N2=2, an 8-port CSI-RS with N1=4 and N2=1, or a 16-port CSI-RS with N1=4 and N2=2.

There may be two signaling approaches. One option may include separate CSI report configurations, where a CSI report configuration includes a full antenna configuration and a new supplemental configuration for reduced antenna configuration. Another option may involve using the same CSI report configuration, where a CSI report configuration is extended by adding a new information element (IE) with supplemental configuration information for a reduced antenna configuration.

As indicated above, FIG. 5 is provided as an example. Other examples may differ from what is described with regard to FIG. 5.

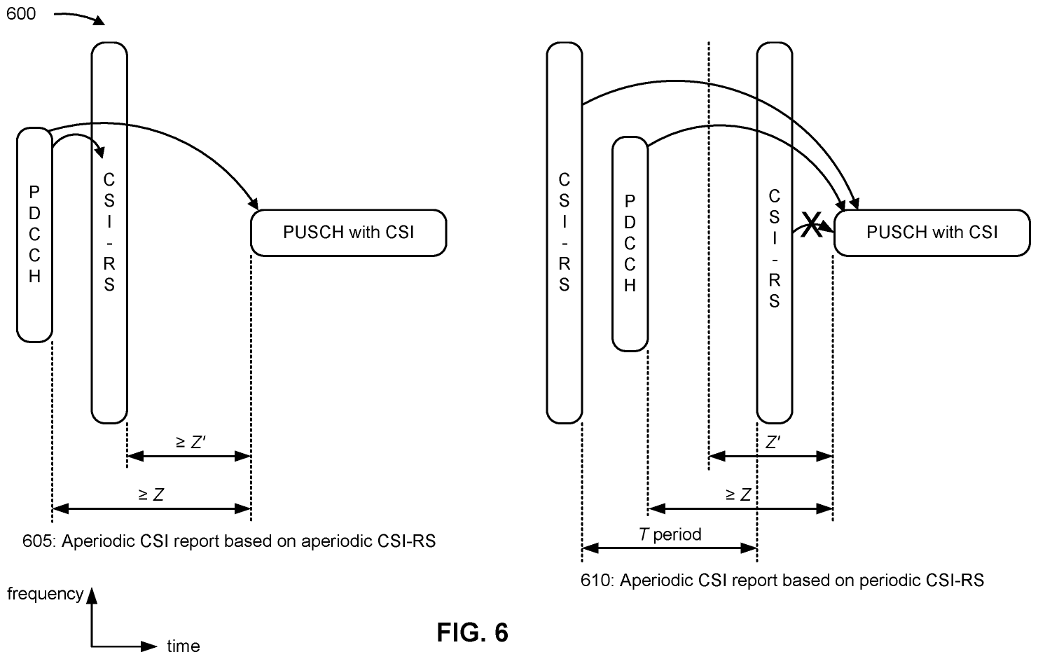

FIG. 6 is a diagram illustrating an example 600 of computing CSI processing parameters, in accordance with the present disclosure.

A UE may determine a CSI computation time associated with a CSI report. For example, in some aspects, a UE may determine a processing time (sometimes referred to as Z) between a physical downlink control channel (PDCCH) including a configuration of a CSI report (e.g., a CSI reporting setting) and a physical uplink shared channel (PUSCH) containing the CSI report. Additionally, or alternatively, the UE may determine a processing time (sometimes referred to as Z′) between a CSI-RS resource associated with a CSI report and the PUSCH containing the CSI report.

More particularly, FIG. 6 illustrates Z and Z′ in the context of an aperiodic CSI report based on an aperiodic CSI-RS, as shown by reference number 605, and in the context of an aperiodic CSI report based on a periodic CSI-RS, as shown by reference number 610. First, for the aperiodic CSI report based on an aperiodic CSI-RS, a period of time between the PDCCH including the configuration of the CSI report and the PUSCH containing the CSI report must be greater than or equal to Z, and the period of time between the CSI-RS resource associated with the CSI report and the PUSCH containing the CSI report must be greater than or equal to Z′. Similarly, for the aperiodic CSI report based on a periodic CSI-RS (e.g., a CSI-RS occurring with a periodicity of T), a period of time between the PDCCH including the configuration of the CSI report and the PUSCH containing the CSI report must be greater than or equal to Z, and the PUSCH can include CSI reports corresponding to CSI-RS resources that occurred greater than or equal to Z′ prior to the PUSCH. Thus, in the depicted example, the PUSCH may include the CSI report corresponding to a first CSI-RS resource (e.g., the leftmost CSI-RS resource) because that resource occurred more than Z′ prior to the PUSCH, but the PUSCH may not include the CSI report corresponding to a second CSI-RS resource (e.g., the rightmost CSI-RS resource) because that resource occurred less than Z′ prior to the PUSCH.

The particular values of Z and Z′ for a given CSI report may depend on whether the CSI report is associated with a fast CSI report time, a low-complexity CSI report time, or a high-complexity CSI report time. For example, a fast CSI report time may be associated with a configured CSI report that occurs when there are no other concurrent CSI reports; when the UE 120 will transmit only the CSI report in a given PUSCH, without other uplink data and without a hybrid automatic repeat request (HARQ) acknowledgement (ACK) feedback; when the configured CSI report is associated with a single CSI-RS resource, with up to four ports and without a CRI; when the configured CSI report is a wideband only report; and when either the configured CSI report is associated with a type I, single-panel codebook, or the configured CSI report is associated with no precoding matrix indicator (PMI) report (e.g., the parameter reportQuantity may be equal to “cri-RI-CQI,” and CRI may not be reported because the configured CSI report is associated with a single CSI-RS resource). In such aspects, for subcarrier spacings of 15 kilohertz (kHz), 30 kHz, 60 kHz, and 120 kHz, Z may be 10 symbols (713.5 microseconds (μs)), 13 symbols (463.8 μs), 25 symbols (446 μs), and 43 symbols (383.5 μs), respectively, and Z′ may be equal to 8 symbols (570.8 μs), 11 symbols (392.4 μs), 21 symbols (374.6 μs), and 36 symbols (321.1 μs), respectively.

A CSI report associated with a low-complexity CSI report time may include many of the attributes of a CSI report associated with a fast CSI report time, except that there may be concurrent CSI calculations and/or multiplexing with data or HARQ ACK in the PUSCH used to transmit the CSI report. That is, a low-complexity CSI report time may be associated with a configured CSI report that occurs when there may be other concurrent CSI reports; when the UE 120 may transmit more than the CSI report in a given PUSCH, such as uplink data and/or a HARQ ACK feedback in addition to the CSI report; when the configured CSI report is associated with a single CSI-RS resource, with up to four ports and without a CRI; when the configured CSI report is a wideband only report; and when either the configured CSI report is associated with a type I, single-panel codebook, or the configured CSI report is associated with no PMI report (e.g., the parameter reportQuantity may be equal to “cri-RI-CQI,” and CRI may not be reported because the configured CSI report is associated with a single CSI-RS resource). In such aspects, for subcarrier spacings of 15 kHz, 30 kHz, 60 kHz, and 120 kHz, Z may be 22 symbols (1569.8 μs), 33 symbols (1177.3 μs), 44 symbols (784.9 μs), and 97 symbols (865.2 μs), respectively, and Z′ may be equal to 16 symbols (1141.7 μs), 30 symbols (1070.3 μs), 42 symbols (749.2 μs), and 85 symbols (758.1 μs), respectively.

A CSI report may be associated with a high-complexity CSI report time if it does not qualify as a fast CSI report or low-complexity CSI report, using the criteria described above, and is not a CSI report associated with a beam management procedure. In such aspects, for subcarrier spacings of 15 kHz, 30 kHz, 60 kHz, and 120 kHz, Z may be 40 symbols (2854.2 μs), 72 symbols (2568.8 μs), 141 symbols (2515.2 μs), and 152 symbols (1355.7 μs), respectively, and Z′ may be equal to 37 symbols (2640.1 μs), 69 symbols (2461.7 μs), 140 symbols (2497.4 μs), and 140 symbols (1248.7 μs), respectively.

While the above-described CSI processing parameters (e.g., the quantity of CSI processing units (CPUs) associated with a CSI report, a number of simultaneously active CSI-RS resources associated with a CSI report, and a CSI computation time associated with a CSI report) may correspond to a CSI processing load at the UE 120 when a single antenna port configuration is implemented (e.g., when a single codebook is utilized for a configured CSI report), the CSI processing parameters may not accurately correspond to the CSI processing load at the UE 120 when the CSI report is configured with multiple codebooks and/or antenna port configurations. More particularly, a network entity (such as a network node 110, an RU 340) may be associated with a massive-MIMO active antenna unit (AAU) that includes multiple, co-located panels consisting of multiple antenna ports. Each panel may be equipped with numerous power amplifiers and antenna subsystems, which consume large amounts of power. For example, more than 20% of all expenses associated with a wireless network may be attributed to energy costs necessary to operate the wireless network, and, of those energy costs, over 50% may be attributed to RAN energy costs. Thus, in an effort to reduce energy consumption or the like, a wireless network may dynamically turn off one or more panels, subpanels, or antenna ports associated with a network entity when the cell load is low.

In such aspects, a configuration of a CSI report (e.g., a CSI reporting setting), may indicate multiple codebooks, each associated with an antenna port configuration. For example, the configuration of the CSI report may indicate a first codebook associated with a base antenna port configuration including 32 antenna ports (e.g., (N₁, N₂)=(4, 4), composed of four panels consisting of (N₁, N₂)=(2, 2) cross-polarized antennas each), which may correspond to an antenna port configuration when no panels or subpanels are turned off. However, the configuration of the CSI report may include additional codebooks associated with reduced antenna port configurations, which May correspond to antenna port configurations when at least one panel or subpanel is turned off. For example, the configuration of the CSI report may indicate a second codebook associated with an antenna port configuration including 4 antenna ports (e.g., (N₁, N₂)=(2, 1)), a third and fourth codebook associated with an antenna port configuration including 8 antenna ports (e.g., (N₁, N₂)=(2, 2) and (N₁, N₂)=(4, 1)), a fifth codebook associated with an antenna port configuration including 16 antenna ports (e.g., (N₁, N₂)=(4, 2)), and so forth.

In such aspects, the UE may need to derive CSI for each codebook and report the CSI for each codebook to the network entity. In some aspects, the UE may do so by providing a supplemental CSI (S-CSI) associated with each of the reduced antenna port configurations (e.g., associated with each of the second through fifth codebooks, described above). In some aspects, the S-CSI may be derived from CSI-RS resources configured for the base antenna port configuration. For example, if 32 CSI-RS resources, comprised of 4 code division multiplexed (CDM) groups, is configured for the base antenna port configuration, the UE may derive an S-CSI associated with each of the reduced antenna port configurations (e.g., associated with each of the codebooks) by using one or more CDM groups, of the four CDM groups, to derive each of the S-CSI. In some aspects, the UE may be configured or hard coded with restriction rules indicating which CSI-RS resources (e.g., which CDM groups) should be used to derive each S-CSI. In some aspects, a same CSI report configuration (e.g., CSI reporting setting) may be used to configure each of the CSI reports (e.g., the CSI report and the additional S-CSI reports), while, in some other aspects, multiple CSI report configurations may be used to configure each of the CSI reports (e.g., a first CSI report configuration) may configure a report associated with the base antenna configuration, while a second CSI report may configure a report associated with the reduced antenna port configurations (e.g., codebooks two through five in the above example).

Some aspects enable accurate CSI processing parameter computations that account for multiple codebook configurations in a given CSI report configuration (e.g., in a given CSI reporting setting). In some aspects, a UE may receive a configuration of a CSI report that includes multiple codebooks, each associated with a corresponding antenna port configuration, and the UE may compute at least one CSI processing parameter based at least in part on the configuration of the CSI report (and thus the multiple codebooks included therein). For example, the UE may compute one or more of a quantity of CPUs associated with a CSI report, a CSI computation time associated with a CSI report, and a number of simultaneously active CSI-RS resources associated with a CSI report, while considering the multiple codebook configurations. This may include computing the number of CPUs based at least in part on a quantity of configured CSI-RS resources and a quantity of the multiple codebooks, computing the CSI computation time associated with the CSI report based at least in part on a pre-configured high-complexity CSI report time and a computation time scaling factor, or computing the number of simultaneously active CSI-RS resources based at least in part on a quantity of the multiple codebooks. By accounting for the multiple codebooks when computing the various CSI processing parameters described herein, a UE may more accurately account for a CSI processing load, leading to robust CSI measurements and reports, and thus improved channel quality, decreased latency, increased throughput, and overall more efficient resource utilization.

As indicated above, FIG. 6 is provided as an example. Other examples may differ from what is described with regard to FIG. 6.

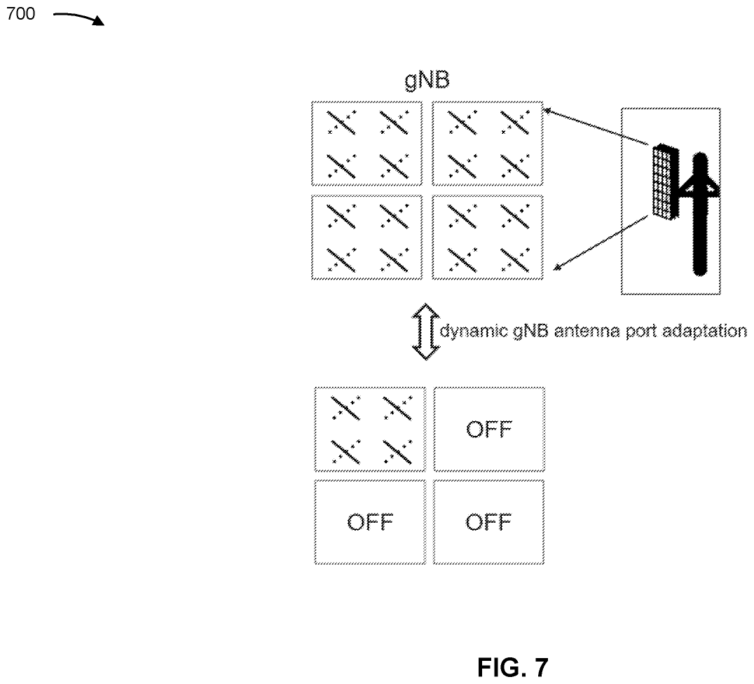

FIG. 7 is a diagram illustrating an example 700 of spatial adaptation, in accordance with the present disclosure.

Spatial adaptation at a network entity may include deactivating one or more antenna panels (spatial elements, ports) such that fewer antenna panels are active. Example 700 shows four antenna panels of a network entity (e.g., gNB). The network entity may deactivate three of the four antenna panels. The three deactivated panels are shown as OFF. Indications related to spatial adaptation may help UEs to adapt a CSI-RS configuration to dynamic or semi-persistent ON-OFF of CSI-RS or to reconfigure the CSI-RS configuration with respect to an adapted number of spatial elements or ports. A network entity may dynamically select CSI report configurations via a selected triggering state (e.g., CSI-AperiodicTriggerStateList, CSI-SemiPersistentOnPUSCH-TriggerStateList) by a MAC CE or DCI.

Codebook configurations may define different types of codebooks for PMI codebook reporting. The different types may include Type 1 single-panel, Type 1 multiple panels, Type II single panel, Type II port selection, Type II enhanced port selection. There may be specific supported configurations of the antenna elements size (N1, N2) and the quantity of panels (Ng) for each codebook type. The corresponding quantity of CSI-RS ports (per resource) may be 2N_{g}N₁N₂. For example, for 32 CSI-RS ports, a supported configuration for (N_{g}, N₁, N₂) may be two antenna panels of dimensions (4, 2).

Power control offsets may also be used to adapt a transmit power for CSI-RSs. In a first step, CSI feedback may be provided for adaptation of power offset values. In a second step, a physical downlink shared channel (PDSCH) may be transmitted with a suitable power offset configuration.

As indicated above, FIG. 7 is provided as an example. Other examples may differ from what is described with regard to FIG. 7.

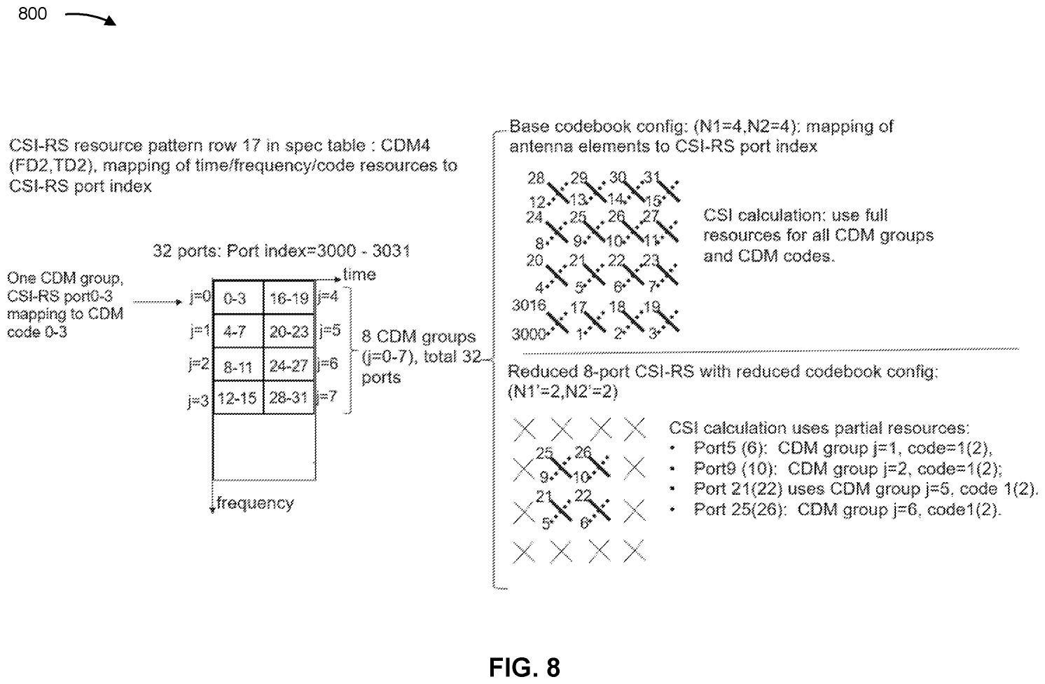

FIG. 8 is a diagram illustrating an example 800 of an antenna subarray pattern from a CSI-RS resource, in accordance with the present disclosure.

Example 800 shows a CSI-RS resource pattern with CSI-RS ports that are mapped to port indices. The 32 ports may be divided into 8 CDM groups (j from 0-7). Example 800 also shows a mapping of antenna elements to CSI-RS port indices as part of a base codebook configuration. For CSI calculation, the UE may use full resources for all CDM groups and CDM codes. Each CDM group can have multiple CDM codes that can be used over the same time-frequency resource. The antenna elements may be for a two-dimensional antenna array with dimensions N1=4 and N2=4, where each side of the two-dimensional antenna array is four antenna elements long. Each antenna element has two CSI-RS ports for a total of 32 CSI-RS ports.

Example 800 further shows a reduced antenna subarray with dimensions N1′=2 and N2′=2. The total quantity of ports is 2×N1′×N2′=8 ports. A CSI calculation may use partial resources. Port 5 is part of CDM group j=1 (code=1). Port 9 is part of CDM group j=2 (code=1). Port 21 is part of CDM group j=5 (code=1). Port 25 is part of CDM group j=6 (code=1).

As indicated above, FIG. 8 is provided as an example. Other examples may differ from what is described with regard to FIG. 8.

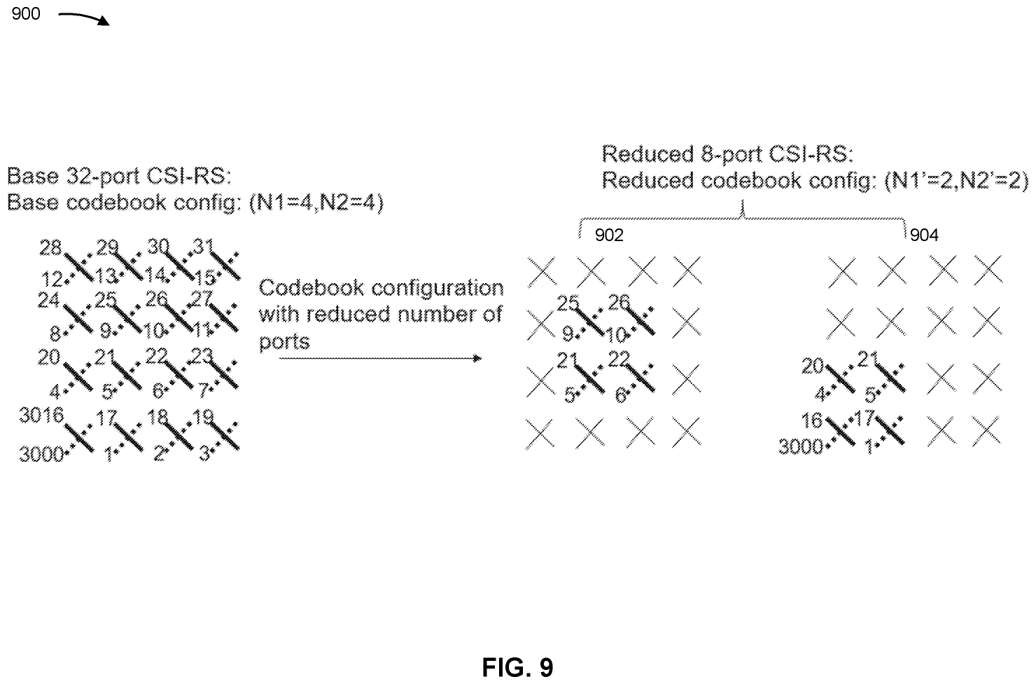

FIG. 9 is a diagram illustrating an example 900 of antenna subarray patterns from a CSI-RS resource, in accordance with the present disclosure.

A network entity (e.g., gNB) may transmit a CSI-RS signal associated with a full antenna array, and the UE may generate multiple CSIs for different antenna subarrays using the same received CSI-RS signal. Each subarray (also referred to as a “derived resource”) is associated with a subset of CSI-RS ports and the corresponding subset of time/frequency/code resources of the CSI-RS signal. The different subarrays are used by the UE for the purpose of CSI calculation.

Example 900 shows antenna subarray 902 and antenna subarray 904 for reduced configuration patterns from within the base codebook configuration. Antenna subarray 902 includes ports 25, 9, 26, 10, 21, 5, 22, and 6. A network entity may explicitly indicate all of the selected ports for antenna subarray 902 by port index, such as 3000+{5, 6, 9, 10, 21, 22, 25, 26}. Antenna subarray 904 includes ports 20, 4, 21, 5, 16, 3000, 17, and 1. The network entity may explicitly indicate all of the selected ports for antenna subarray 904 by port index, such as 3000+{0, 1, 4, 5, 16, 17, 20, 21}. However, the signaling overhead for each antenna subarray is 5 bits×8 ports=40 bits.

In some aspects, a UE may receive an indication of the antenna subarray with fewer signaling resources. The indication may indicate a starting port and a size of the antenna subarray, by which the UE can derive the subset of ports associated with the antenna subarray. Since there is a one-to-one mapping between a port index and the CSI-RS resource in time/frequency/code domain, with the derived set of selected ports, the UE may determine the corresponding CSI-RS resources (time/frequency/code) associated with the selected ports of the received CSI-RS signal and generate CSI for the subarray with a reduced size based at least in part on these selected resources. By indicating only the starting port (and not all of the ports), the UE may reduce the signaling overhead for the ports from 40 bits to 5 bits.

In order to save power consumption at the network entity (e.g., gNB) side, the network entity may dynamically turn on and off some of the transmit antenna elements based on channel conditions and traffic loading of different UEs. For example, for a close-by UE with very good channel conditions and/or low traffic loading (e.g., web browsing), the most energy efficient scheme for the network entity may be to turn off some of the transmit antenna elements and transmit to the UE with a low data rate. In another example, for a cell-edge UE with poor channel conditions and/or high traffic demands, the most energy efficient scheme for the network entity may be to turn on all of its transmit antenna elements and transmit to the UE with the highest achievable rate. The network entity may have various options on the quantity/locations of antenna elements (called spatial adaptation patterns) to choose from. In order to help the network entity to make the right decision, the network entity may collect CSI (e.g., CQI/PMI/RI) from the UE for different spatial adaptation patterns. The existing CSI framework defines signaling messages for configuring a CSI report and the CSI-RS resources used by the UE to generate the CSI report. The aspects described herein, enhance the CSI framework for spatial adaptation.

In the existing CSI framework, for each spatial adaptation pattern, the network entity is expected to configure a separate CSI-RS resource corresponding to the spatial adaptation pattern for the UE to perform channel measurements. With this approach, the quantity of CSI-RS resources required for supporting spatial adaptation scales with the quantity of patterns, and the overhead may be large. For example, if the network entity wants to obtain CSI measurements for an antenna array of (32, 16, 8, 4) antenna elements, at least 4 CSI-RS resources with (32, 16, 8, 4) ports is to be configured.

Previous solutions involve using one CSI-RS resource for channel measurements of different spatial patterns, such as using a 32-port CSI-RS resource to measure CSI associated with an antenna array of (32, 16, 8, 4) elements. To calculate CSI for a spatial pattern, the UE may only use a subset of ports from the configured CSI-RS resource. In some aspects, the network entity may enhance signaling to indicate the set of selected ports from the configured CSI-RS resource for a spatial pattern. The UE may derive a subset of ports and identify the time/frequency/code resources associated with the selected subset of ports from the received CSI-RS signal to perform channel measurements. The UE may generate a CSI report for a spatial adaptation pattern with a reduced array size. As a result, the network entity conserves power and signaling resources.

In further detail, there may be two steps for a spatial adaptation procedure. The first step involves channel estimation for different spatial patterns. A spatial pattern may refer to an antenna subarray with a (size, starting location) inside a full antenna array. The second step involves, based on CSI feedback from the UE in the first step, the network entity determining to use a specific spatial pattern for data transmission. That is, the network entity may turn on a specific subarray to save power.

The aspects described herein relate to the first step, where the network entity obtains multiple CSI(s) that are fed back from the UE, each corresponding to one spatial pattern. One solution, in some aspects, involves the network entity transmitting separate CSI-RS signals for each spatial pattern, and then the quantity of CSI-RS signals scales with the quantity of spatial patterns. An enhanced approach, in some aspects, is to transmit one CSI-RS signal and instruct the UE to feed back CSI(s) for multiple spatial patterns by processing the same received CSI-RS signal. For example, the network entity may transmit a CSI-RS signal with 32 ports and instruct the UE to feed back CSI(s) for multiple spatial patterns: full array with 32 elements (N1=4, N2=4), and subarray 1 with 16 elements (N1=4, N2=2), where the starting element location corresponds to an element associated with port 3000 in the full array.

For an existing CSI framework, one CSI report configuration may include one or more resource sets, and one resource set may include one or more CSI-RS resources. Different CSI-RS resources in the same resource set may be non-overlapping, fully-overlapping or partially overlapping. The network entity may dynamically select one resource set when triggering an aperiodic CSI report via DCI. For one CSI report, the UE may perform measurements on all CSI-RS resources over the resource set selected by the network entity, select the best CSI-RS resource, calculate CSI(s), and report the selected CRI and the associated CSI(s).

In some aspects, for a spatial adaptation pattern configured for a CSI report, if the CSI report is configured with multiple CSI-RS resources, one or more CSI-RS resources may be selected as the base CSI-RS resource for this spatial adaptation pattern. Example 900 in FIG. 9 shows an example of one base CSI-RS resource. In general, there can be multiple base CSI-RS resources, and each base resource can be used to derive a reduced CSI-RS resource for the spatial adaptation pattern via a set of selected ports. The network entity may indicate the selected one or more CSI-RS resources for the spatial adaptation pattern in the CSI report configuration or transmit a separate signaling message (e.g., the triggering DCI for the CSI report or the configuration message for triggering states). The UE may indicate the selected one or more CSI-RS resources in the CSI report message. In some aspects, the selected CSI-RS resource set(s) may be indicated for the spatial pattern together with selected base resource(s). If no selection is indicated, each of the CSI-RS resources configured for the CSI report may be used as the base CSI-RS resource for the spatial pattern.

However, there may be a large amount of signaling overhead involved with supporting different spatial adaptations or different power control values. Different CSI report configurations may involve different antenna subarray sizes and DFT beam restrictions. One CSI report configuration can support only one codebook configuration and only one spatial pattern. Associated CSI-RS resources in a CSI report configuration are restricted to the same quantity of CSI-RS ports as in the codebook. Power control offsets are configured per CSI-RS resource, and the RRC signaling for power control offsets scales with the quantity of power control values.

According to various aspects described herein, a UE may receive an adaptation indication that includes a spatial adaptation indication and/or a power adaptation indication. The spatial adaptation indication may indicate one or more adaptation items, such as derived resources that are associated with a first CSI-RS base resource, each derived resource including a subset of CSI-RS ports of a network entity that are derived from the first CSI-RS base resource. The adaptation indication may include a power adaptation indication that indicates other adaptation items, such as one or more power offsets for the first CSI-RS base resource or for the one or more derived resources. The adaptation indication may include only the spatial adaptation indication, only the power adaptation indication (e.g., for the CSI-RS base resource), or both (joint spatial adaptation and power adaptation). Adaptation items may be part of one or more adaptation sets.

The spatial adaptation may indicate one or more derived resources associated with a first CSI-RS base resource, where each derived resource including a subset of CSI-RS ports of a network entity that are derived from the first CSI-RS base resource. The power adaptation indication may indicate one or more power offsets for the first CSI-RS base resource or for the one or more derived resources. The UE may transmit CSI feedback based at least in part on one or more of measurement of a CSI-RS from the one or more derived resources, measurement of the one or more derived resources in association with the power offset, and/or measurement of a base CSI-RS transmitted from the first CSI-RS base resource in association with the power offset. By receiving an adaptation indication, the UE may reduce the signaling overhead and conserve signaling resources.

In some aspects, the power offsets may not be used for transmission. Rather, the power offsets may be used in association with measurements. That is, the power offsets may be virtual power offsets that are assumed or hypothetical power offsets used for CSI calculation. For example, the UE may compute CSI(s) for different assumed power offsets (e.g., {CSI1(powerOffset1), CSI2(powerOffset2), . . . } by measuring the base CSI-RS resource with powerOffset0. In this way, a single resource with a single transmit power can be measured and used in association with one or more power offsets to derive CSI(s) for different transmit powers.

Different types of power offsets may be configured for a CSI-RS resource. A first power control offset may be powerControlOffsetSS (the power offset between the base CSI-RS and an SSS). The first power control offset may be used to adapt a transmit power for CSI-RSs. The transmitted power of a CSI-RS may be determined by this power offset relative to the power of the SSS.

A second power control offset may be called powerControlOffset (the power offset between the PDSCH and the base CSI-RS). The second power control offset May be used to adapt a transmit power for PDSCH. The second power offset may be used only for the purpose of CSI calculation (is not used to determine a transmission power of CSI-RS), because the CSI value is for the PDSCH with powerControlOffset relative to the CSI-RS signal on which the measurement is carried.

In some aspect, power adaptation may refer to adapting the transmit power of a CSI-RS and/or refer to adapting the transmit power of a PDSCH with a fixed CSI-RS power. For either case, a network entity may expect the UE's feedback of CSIs over a list of power offset values, so that the network entity can determine the best power offset value used for PDSCH and/or for later CSI-RS transmissions.

In an existing CSI framework, both power offsets can be configured for a CSI-RS resource inside the “NZP-CSI-RS-resource IE”. For example, in order to get the CSI feedback for a list of powerOffset values (e.g., {value1, value2, . . . } of PowerControlOffsetSS or PowerControlOffset), the network entity may configure multiple CSI-RS resources, each with a different power offset value, which have significant resource/configuration/signaling overhead. For an enhanced scheme, the network entity may configure one base CSI-RS resource with (PowerControlOffsetSS_value0, PowerControlOffset_value0}, and configure an adaptation set with a list of virtual or hypothetical power offset values {value1, value2, . . . } for either PowerControlOffsetSS or PowerControlOffset. The network entity may transmit a CSI-RS with a PowerControlOffsetSS_value0 relative to SSS power, and the UE may measure the received CSI-RS signal and calculate CSI(s) for each of the hypothetical power offset values in the list. The UE may feed back CSI(s) for one or more selected hypothetical power offset values according to selection criterion specified in stored configuration information or configured by the network entity.

In some aspects, the adaptation indication may indicate a CSI-RS base resource for each adaptation item (e.g., derived resource, virtual power offset) in an adaptation set. In some aspects, the adaptation indication may indicate one or more parameters for each adaptation item. These parameters may be not the parameters configured or associated with a CSI-RS base resource. These parameters may be intended to replace the corresponding parameters configured for the CSI base resource when calculating CSI for an adaptation item. For example, the parameter indicating a subset of ports may replace all the ports of the CSI-RS base resource. In another example, the virtual power offset parameter may replace the power offset parameter of the CSI-RS base resource. In some aspects, a parameter may include a cost factor. In some aspects, the adaptation indication may include an indication of a codebook configuration with a parameter that indicates a size of a two-dimensional antenna subarray associated with one or more derived resources in an adaptation set. The subarray may have a reduced size from the full antenna array associated with the CSI-RS base resources of the derived resources.

As indicated above, FIG. 9 is provided as an example. Other examples may differ from what is described with regard to FIG. 9.

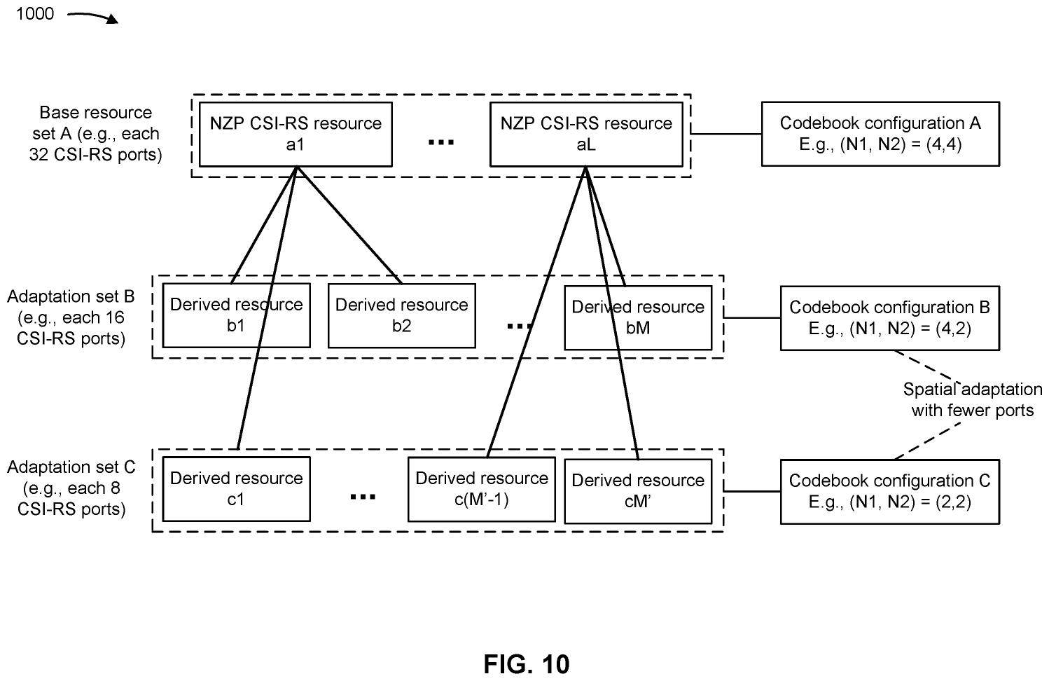

FIG. 10 is a diagram illustrating an example 1000 of derived resources, in accordance with the present disclosure.

In some aspects, adaptation items in the same adaptation set, such as derived resources in the same resource set, may be associated with the same codebook configuration with same quantity of ports. Example 1000 shows an example of adaptation items in adaptation sets (e.g., derived resources in resource sets, which may be derived resource sets). An adaptation item may include a derived resource or a virtual power offset (power offset used for CSI calculation but not for actual transmission). Example 1000 shows adaptation sets with adaptation items that are derived resources. A CSI report configuration may include a base resource set (e.g., 32 ports) with CSI-RS base resources (e.g., NZP CSI-RS resource al through NZP CSI-RS resource aL) that are associated with a first codebook configuration. The CSI report configuration may include a first adaptation set of derived resources b1 to bM (e.g., 16 ports each) that are associated with a second codebook configuration. The CSI report configuration may include a second adaptation set of derived resources c1 to cM′ (e.g., 8 ports each) that are associated with a third codebook configuration. At least one derived resource of the first adaptation set (e.g., derived resource b1 and derived resource b2) and at least one derived resource of the second adaptation set (e.g., derived resource c1) may be associated with a first CSI-RS base resource. At least one derived resource of the second adaptation set (e.g., derived resource bM) and at least one derived resource of the second adaptation set (e.g., derived resource cM′−1 and derived resource cM′) may be associated with a second CSI-RS base resource.

As indicated above, FIG. 10 is provided as an example. Other examples may differ from what is described with regard to FIG. 10.

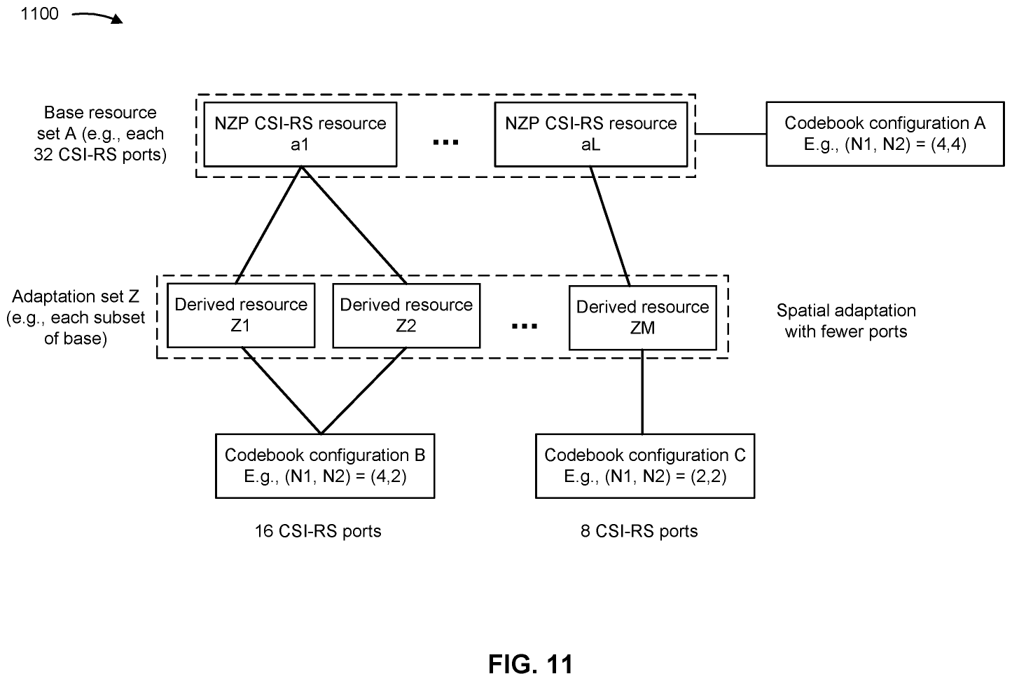

FIG. 11 is a diagram illustrating an example 1100 of derived resources, in accordance with the present disclosure.

In some aspects, different derived resources in the same adaptation set may be associated with different codebook configurations and may have different quantities of ports. For example, different derived resources may be associated with different codebook configurations regardless of whether they are associated with the same CSI-RS base resources. In another example, different derived resources associated with the same CSI-RS base resources may be associated with the same codebook configuration, and different derived resources associated with different CSI-RS base resources may be associated with different codebook configurations.

Example 1100 shows two derived resources of a first resource set Z are associated with a first CSI-RS base resource and a first codebook configuration. Another derived resource of the first resource set Z may be associated with a second CSI-RS base resource and a second codebook configuration.

As indicated above, FIG. 11 is provided as an example. Other examples may differ from what is described with regard to FIG. 11.

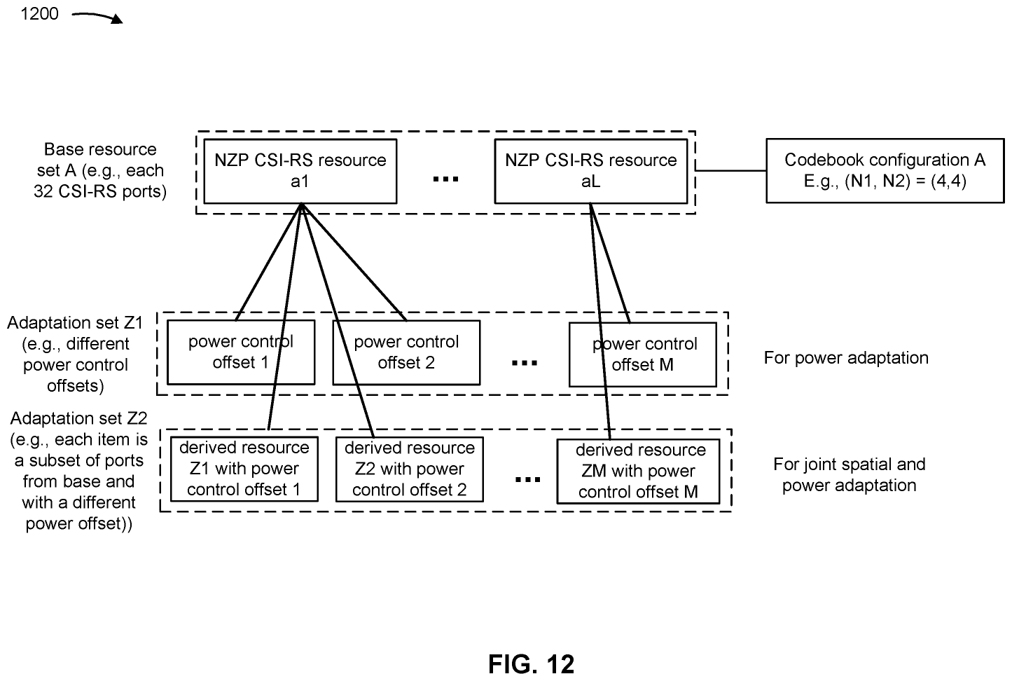

FIG. 12 is a diagram illustrating an example 1200 of derived resources, in accordance with the present disclosure.

In some aspects, no codebook configuration may be associated with the derived sets, and the derived resource may be the same as its associated CSI-RS base resource, but with one or more power control offsets applied. The one or more power control offsets may be a power offset between a PDSCH and a base CSI-RS of the CSI-RS base resource (e.g., powerControlOffset) and/or a power offset between the base CSI-RS and an SSS (e.g., powerControlOffsetSS).

Example 1200 shows power control offsets of different CSI-RS base resources. A network entity may adapt a power used to transmit a base CSI-RS from a CSI-RS base resource. The CSI-RS base resources may be part of a base resource set that is associated with a codebook configuration.

An adaptation item may include a derived resource or a hypothetical power offset. Example 1200 also shows derived resources of different CSI-RS base resources. The derived resources may have a power offset value assigned to each derived resource, as part of a joint spatial and power adaptation. A network entity may adapt a power used to transmit a CSI-RS from the derived resources.

In some aspects, a UE may select derived resources for CSI reporting. The UE may report CSI for one or more adaptation items in the adaptation set, and the reported CRI for spatial/power adaptation may refer to the index of selected adaptation items in an adaptation set. The quantity of reported derived resources (K) may be configured or specified. There may be special cases, where K=1, or K=size (adaptation set). Each adaptation item may be associated with a cost factor, and the UE's selection criterion for the best resource index to be included in the CSI report may depend on the cost factor. For example, the cost factor for an adaptation item may be an indicator of a network entity's energy consumption when using an adaptation scheme. The selection criterion may be the resource with the best signal quality and/or cost factor, where the signal quality may be one of reported CSI values (e.g. RSRP, CQI, signal-to-interference-plus-noise ratio (SINR)).

As indicated above, FIG. 12 is provided as an example. Other examples may differ from what is described with regard to FIG. 12.

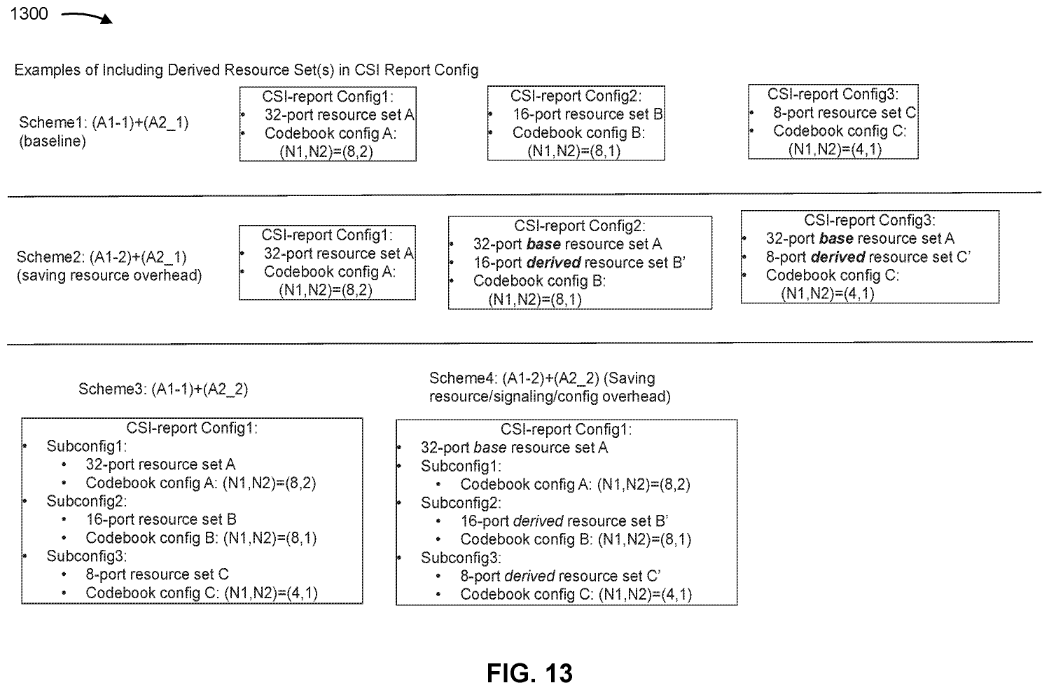

FIG. 13 is a diagram illustrating an example 1300 of CSI report configurations, in accordance with the present disclosure.

Example 1300 shows different configuration schemes that a network entity may use to configure a UE or to indicate derived resources or power offsets. For example, a first scheme may include three CSI report configurations of different quantities of CSI-RS ports. A second scheme may include CSI report configurations for base resource sets and adaptation sets. A third scheme may include a CSI report configuration with sub-configurations for different quantities of CSI-RS ports and with different codebook configurations. A fourth scheme may include a base resource set, sub-configurations, and codebook configurations.

As indicated above, FIG. 13 is provided as an example. Other examples may differ from what is described with regard to FIG. 13.

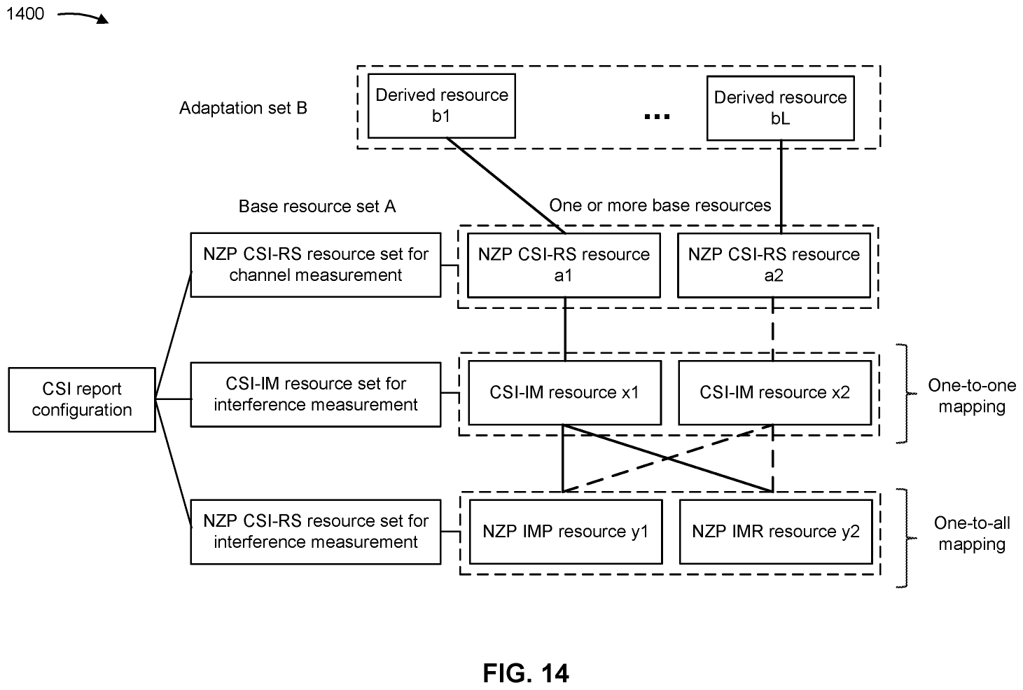

FIG. 14 is a diagram illustrating an example 1400 of derived resources, in accordance with the present disclosure.

In some aspects, for an adaptation item in an adaptation set (e.g., derived resource in a resource set) for spatial adaptation or power adaptation, the IMR may be a derived resource that is associated with the base NZP CSI-RS resource from which the derived CSI-RS resource is obtained. Example 1400 shows a CSI report configuration that includes multiple base resource sets associated with adaptation sets. The base resources may be mapped on-to-one to IMRs. The IMRs may be mapped one-to-all to NZP IMR resources.

As indicated above, FIG. 14 is provided as an example. Other examples may differ from what is described with regard to FIG. 14.

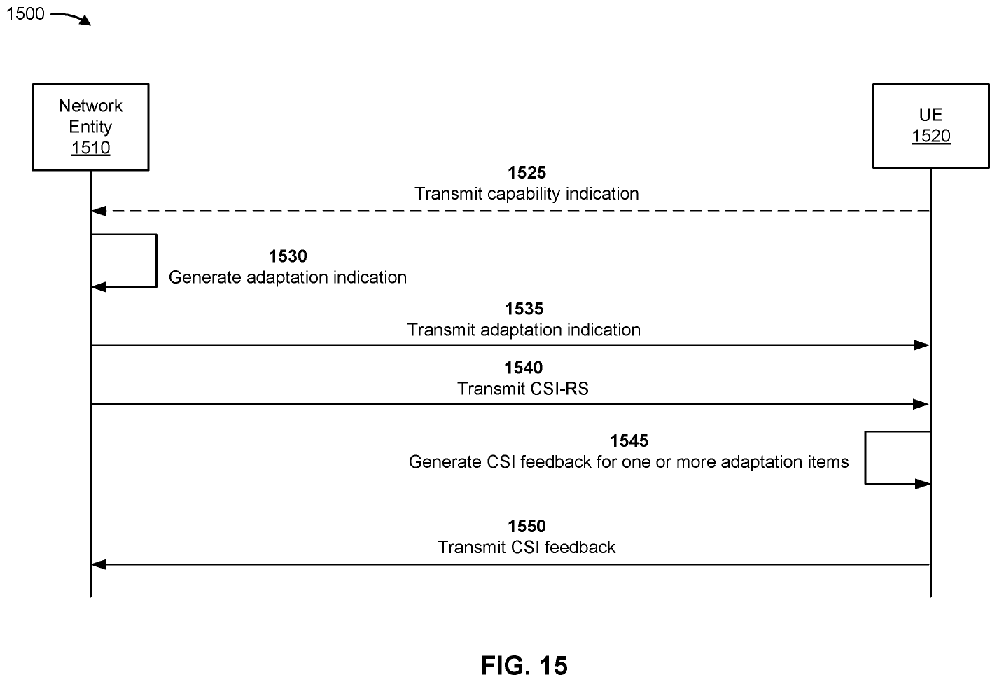

FIG. 15 is a diagram of an example 1500 associated with indicating an antenna subarray, in accordance with the present disclosure. As shown in FIG. 15, a network entity 1510 (e.g., network node 110) and a UE 1520 (e.g., UE 120) may communicate with each other via a wireless network (e.g., wireless network 100).

As shown by reference number 1525, the network entity 1510 may optionally transmit a capability indication. In some aspects, the capability indication may indicate where the UE 1520 supports a joint CSI report that includes multiple CSIs associated with multiple adaptation sets for spatial and/or power adaptation. If the UE 1520 does not provide the capability, the UE 1520 may report a separate CSI report for each CSI corresponding each adaptation set. The capability may be defined per UE, per band, per band combination, or per feature group. Separate capabilities can be for spatial or power adaptation.

In some aspects, for the adaptation of power offset values between a PDSCH and the CSI-RS, the UE 1520 may reports its capability on supporting a joint CSI report that includes multiple CSIs associated with multiple power offset values. If the UE 1520 does not provide the capability, the UE 1520 may report a separate CSI report for each CSI corresponding each power offset value. The capability may be defined per UE, per band, per band combination, or per feature group.

As shown by reference number 1530, the network entity 1510 may generate an adaptation indication. The adaptation indication may be a spatial adaptation indication or a power adaptation indication. Further details are included below.

As shown by reference number 1535, the network entity 1510 may transmit the adaptation indication. The adaptation indication may include a spatial adaptation indication that indicates one or more adaptation items, such as derived resources that are associated with a first CSI-RS base resource, each derived resource including a subset of CSI-RS ports of a network entity that are derived from the first CSI-RS base resource. The adaptation indication may include a power adaptation indication that indicates other adaptation items, such as one or more power offsets for the first CSI-RS base resource or for the one or more derived resources. Power offsets may be virtual power offsets that are hypothetical power offsets that are used for CSI calculation and not for actual CSI-RS transmission. The adaptation indication may include only the spatial adaptation indication, only the power adaptation indication (e.g., for the CSI-RS base resource), or both (joint spatial adaptation and power adaptation). Adaptation items may be part of one or more adaptation sets.

In some aspects, the adaptation indication may be a CSI report configuration. The adaptation indication may be a triggering state indication. As shown by reference number 1540, the network entity 1510 may transmit a CSI-RS. The CSI-RS may be transmitted from a derived resource. The CSI-RS may be transmitted with an adapted power.

As shown by reference number 1545, the UE 1520 may generate CSI feedback based at least in part on measuring the CSI-RS. The CSI feedback may be for one or more adaptation items (e.g., derived resources, virtual power offsets). The CSI feedback may be generated based at least in part on a CSI report configuration. The CSI feedback may be generated based at least in part on any CSI base resources indicated in the CSI report configuration. The CSI feedback may be generated based at least in part on any adaptation items indicated in the CSI report configuration. As shown by reference number 1550, the UE 1520 may transmit the CSI feedback. The network entity 1510 may receive the CSI feedback and transmit PDSCH communications based at least in part on the CSI feedback.

The UE 1520 may generate a CSI report based at least in part on reference signals that are transmitted from a derived resource (e.g., subset of CSI-RS ports). The network entity 1510 may activate only the subset of CSI-RS ports, and the UE 1520 may measure the reference signals associated with the subset of CSI-RS ports. Other CSI-RS ports may be deactivated. The UE 1520 may measure the reference signals and generate CSI based at least in part on the measurements and include the CSI in the CSI report. In some aspects, the UE 1520, having derived the subset of CSI-RS ports, may identify the time/frequency/code resources associated with the selected subset of CSI-RS ports from the received CSI-RS signal to perform channel measurements. In some aspects, the UE 1520 may have a single antenna element to receive a CSI-RS signal transmitted from the network entity 1510 with N transmit antenna elements. The CSI-RS signal with N-ports spans orthogonal time/frequency/code-domain resources, and thus a received signal for each transmit port may be separated by the UE 1520 with one receive antenna and the corresponding channel for each transmit port can be measured. As shown by reference number 1550, the UE 1520 may transmit the CSI report. By indicating derived resources or other parameters in an adaptation indication, the network entity 1510 may conserve signaling resources and help the UE 1520 to conserve energy and processing resources.

In some aspects, for a derived resource in an adaptation set for spatial adaptation or power adaptation, the associated IMR may be associated with a base NZP CSI-RS resource from which the derived CSI-RS resource is obtained.

In some aspects, there may be restrictions on adaptation sets to keep CSI processing at the UE 1520 manageable and to provide useful CSI feedback to the network entity 1510. For example, if the network entity 1510 configures Ks=16, but the UE 1520 is only able to the finish processing of 8 CSIs before the reporting time and to feed back one of 8 CSIs to the network entity 1510, such reported CSI may not be optimal because the CSIs associated with the remaining CSI-RS resources have not been processed yet. In another example, if Ks=2 CSI-RS resources are configured, each resource may contain at most 16 CSI-RS ports. If 2<Ks≤8 CSI-RS resources are configured, each resource may contain at most 8 CSI-RS ports.

In some aspects, a configuration may impose one or more restrictions on an adaptation set for spatial adaptation or power adaptation and/or its associated base resource set. The restriction may be the maximum quantity of resources that can be included in the adaptation set. The maximum quantity of resources may be based at least in part on a maximum quantity of ports of the resource. The restriction may be different for the base resource set and/or for the adaptation set. For example, the maximum quantity of resources for the base resource set may be 1. In an example, the maximum quantity of resources for the base resource set may be I if the quantity of ports for the base resource is 32 or 24, or 2 if the quantity of ports Y for the base resource is 16. In an example, the maximum quantity X of resources for the adaptation set may be X=1 if the quantity of ports Y=32 or 24; X=2 if Y=16; or X=8 if 2<Y≤8. In an example, the maximum quantity X of resources for the adaptation set may depend on a scaling factor a reported by UE that characterizes its CSI processing load scaling with a quantity of derived resources in a resource set (e.g., X(derived)=X(spec)/a), where a is a load scaling factor. If multiple adaptation sets are included in a CSI report configuration or in a CSI resource setting or in a triggering state, the network entity may impose restrictions on the maximum quantity of total derived resources across multiple adaptation sets.

Other examples of adaptation indications are provided. In some aspects, the UE 1520 may receive an adaptation indication that indicates a first adaptation set with one or more derived resources, and for each derived resource in the first adaptation set, an indication of an associated CSI-RS base resource and one or more associated parameters. The UE 1520 may transmit CSI feedback for one or more derived resources, where the CSI feedback for a derived resource is obtained based at least in part on measurement of the associated CSI-RS base resource and the associated parameters indicated by the adaptation indication for the derived resource. In some aspects, the network entity 1510 may indicate associated parameters for a CSI-RS base resource in a separate signaling message different from the adaptation indication. The adaptation indication may then include a pointer of the CSI-RS base resource for a derived resource. The parameters may be included in, for example, a codebook configuration. The parameters may include a power control offset or a power control offset secondary synchronization (SS) of a CSI-RS base resource. In some aspects, an adaptation indication may include spatial adaptation only, power adaptation only, or a joined power and spatial adaptation.

In some aspects, the one or more associated parameters indicated for a derived resource may include a spatial adaptation parameter that indicates a subset of CSI-RS ports of the associated CSI-RS base resource that are used for channel measurements for the derived resource, where the subset has fewer CSI-RS ports than the total quantity of CSI-RS ports of the associated CSI-RS base resource. For example, a spatial adaptation parameter may include the starting port index of the subset of CSI-RS ports, an indication of the subarray size (N1′,N2′) for the derived resource, a list of port indices for the subset of CSI-RS ports, and/or a bitmap (of 0 or 1) to indicate the subset of CSI-RS ports.

In some aspects, the one or more associated parameters may include a codebook configuration with parameters for calculation of a PMI for the derived resource with a subarray of a reduced size from the antenna array associated with the CSI-RS base resource. If the previous adaptation parameter is indicated by a bitmap or a list of port indices, the previous adaptation parameter together with a codebook configuration of the CSI-RS base resource may be sufficient to indicate derived resources. If the previous adaptation parameter only indicates the starting port index of the subset of CSI-RS ports, or if different PMI parameters are to be used from the base resource, the network entity 1510 may indicate the codebook configuration.

In some aspects, the one or more associated parameters may include a first power adaptation parameter that indicates an assumed or hypothetical power offset value between the PDSCH and the derived resource for the purpose of CSI calculation. The power adaptation parameter may be different from an indicated power control offset parameter (e.g., powerControlOffset) for the associated CSI-RS base resource.

In some aspects, the one or more associated parameters may include a second power adaptation parameter that indicates an assumed or hypothetical power offset value between the derived resource and an SSS for the purpose of CSI calculation, which is different from an indicated power control offset for an SS (e.g., powerControlOffsetSS) for the associated CSI-RS base resource. Note that the power offset value(s) for a derived resource are some hypothetical values for purpose of CSI calculation and may not actually be used to set a transmit power. The signal actually transmitted is the base CSI-RS with powerControlOffsetSS.

In some aspects, the first power adaptation parameter and/or the second power adaptation parameter may be used for a derived resource in the case of power adaptation. In one example, the network entity 1510 may indicate parameters only for spatial adaptation and use the same power offset values as the CSI-RS base resource (no power adaptation). In another example, the network entity 1510 may indicate parameters only for power adaptation and use the same spatial parameters as the CSI-RS base resource (no indication of a subset of CSI-RS ports). For power adaptation, the network entity 1510 may indicate one or both power offsets (that are different from the CSI-RS base resource). In another example, the network entity 1510 may indicate joint power and spatial adaptation and include both spatial adaptation and power adaptation parameters.

In some aspects, the calculation of CSI feedback for a derived resource may be based at least in part on the parameters associated with the CSI-RS base resource that are not overridden by the parameters indicated by the adaptation indication. The parameters associated with the CSI-RS base resource may be indicated to the UE 1520 in a separate signaling message different from the adaptation indication or in the same adaptation indication. In some aspects, the associated parameters for a CSI-RS base resource may be the parameters configured for the CSI-RS base resource, the parameters configured for a CSI-RS resource set or a CSI-RS resource setting, or a CSI report configuration that includes the CSI-RS base resource or is linked to the CSI-RS base resource.

For example, the interference resource used for CSI calculation for a derived resource may be the one associated with the base CSI-RS resource of the derived resource. In another example, if the associated parameters for a derived resource indicated in the adaptation indication only includes power adaptation parameters, the spatial parameters (e.g., codebookConfig) used for CSI calculation of the derived resource may be the one associated with the CSI-RS base resource of the derived resource. The codebookConfig associated with a CSI-RS base resource may be the one configured in the CSI report configuration that the CSI-RS base resource is linked with. In another example, if the associated parameters for a derived resource indicated in the adaptation indication only includes spatial adaptation parameters, the power offset parameters used for CSI calculation of the derived resource may be the power offset parameter associated with the CSI-RS base resource of the derived resource.

In some aspects, the UE 1520 may select derived resources for the transmission of CSI feedback. The network entity 1510 may indicate the quantity of derived resources selected for CSI feedback, or the quantity may be specified in stored configuration information at the UE 1520. A special case for the quantity of derived resources selected for reporting may be 1, which can be specified. A special case for the quantity of derived resources selected for reporting may be equal to the quantity of derived resources inside the first resource set. That is, the CSI of all derived resources may be reported (and can be specified).

In some aspects, the derived resource(s) selected by the UE 1520 for CSI feedback may be indicated in the CSI feedback with the corresponding indices of the selected resource(s) within the first resource set. This may include using CRIs. The selection of the derived resources for CSI feedback within the first resource set is based at least in part on the measured signal quality of each derived resource in the first resource set.

In some aspects, the selection of derived resources for CSI feedback within the first resource set may be based at least in part on one or more cost factors indicated by the network entity for each derived resource and the measured signal quality of each derived resource in the first resource set.

In some aspects, the network entity 1510 may indicate a mapping of derived resources with base resources in a base resource set. The derived resources in the first adaptation set may be associated with CSI-RS base resources in a first base resource set, where the mapping is that a subset of derived resources in the first adaptation set may be associated with a base resource in the first base resource set in sequence. In some aspects, the network entity 1510 may indicate the first subset of derived resources in the first adaptation set associated with a first CSI-RS base resource in the first resource base set and a second subset of derived resources in a second adaptation set associated a second CSI-RS base resource in the first base resource set. In a special case, there may be a one-to-one mapping. In some aspects, a mapping of the adaptation sets to the base CSI-RS resource sets may be indicated in a CSI report configuration. For example, the index of the associated CSI-RS resource set may be configured for each adaptation set. In another example, a mapping of the adaptation sets to the base CSI-RS resource sets may be dynamically indicated by a triggering state via a scheduling grant (e.g., the base resource set associated for the adaptation set(s) configured in a CSI report configuration is the base set indicated by the triggering state that triggers the configured CSI report). In some aspects, one or more adaptation sets for spatial adaptation or power adaptation may be included in a triggering state together with a selected CSI-RS base resource set and a selected CSI-RS report configuration.

In some aspects, the network entity 1510 may indicate a codebook configuration of derived resources. The derived resources in the first adaptation set may share the same codebook configuration. The subset of derived resources in the first adaptation set that are associated with the same base resource may share the same codebook configuration.

In some aspects, one adaptation indication may include multiple adaptation sets, such as a first adaptation set and a second adaptation set. In one example, both adaptation sets may be associated with the same base resource set. In another example, the adaptation sets may be associated with different base resource sets.

In some aspects, the UE 1520 may transmit CSI feedback for each adaptation set indicated in the adaptation indication. If the UE 1520 receives a second adaptation indication from the network entity 1510, which selects one or more adaptation set(s) from the multiple adaptation sets indicated in the first adaptation indication, the UE 1520 may transmit CSI feedback for each adaptation set indicated by the second adaptation indication. In some aspects, the UE 1520 may transmit CSI feedback for a subset of adaption sets indicated by the second adaptation indication.

In some aspects, the adaptation indication may be included in one or more of following RRC information elements: CSI-MeasConfig, CSI-reportConfig, CSI-ResourceConfig, NZP-CSI-RS-ResourceSet, CSI-SemiPersistentPUSCH-TriggerState, CSI-AperiodicTriggerState, or CSI-AssociatedReportConfigInfo.

In some aspects, the spatial adaptation indication includes a first CSI-RS report configuration. In some aspects, the first CSI-RS report configuration indicates a first adaptation set with at least one derived resource (e.g., subset of CSI-RS ports) where each subset has a first quantity of CSI-RS ports that is less a quantity of CSI-RS ports of the first base CSI-RS resource, and the first adaptation set is associated with the first base CSI-RS resource.

In some aspects, the at least one subset of CSI-RS ports includes multiple subsets having a same quantity of CSI-RS ports, and each subset of the multiple subsets has a different starting CSI-RS port. Different derived resources in the first adaptation set may have the same quantity of CSI-RS ports but different starting CSI-RS port indices.

In some aspects, the spatial adaptation indication includes a second CSI-RS report configuration. The second CSI-RS report configuration may indicate a second adaptation set with at least one subset of CSI-RS ports where each subset has a second quantity of CSI-RS ports that is less than the first quantity of CSI-RS ports, and the second adaptation set is associated with the first base CSI-RS resource.

In some aspects, the second CSI-RS report configuration may indicate a second adaptation set with at least one subset of CSI-RS ports where each subset has a second quantity of CSI-RS ports that is less than the first quantity of CSI-RS ports, and the second adaptation set is associated with a second base CSI-RS resource. In some aspects, the second CSI-RS report configuration may indicate at least one subset of CSI-RS ports from the first adaptation set that is associated with a second base CSI-RS resource.

As indicated above, FIG. 15 is provided as an example. Other examples may differ from what is described with regard to FIG. 15.

FIG. 16 is a diagram illustrating an example process 1600 performed, for example, by a UE, in accordance with the present disclosure. Example process 1600 is an example where the UE (e.g., UE 120, UE 1520) performs operations associated with indication of derived resources or a power control offset.

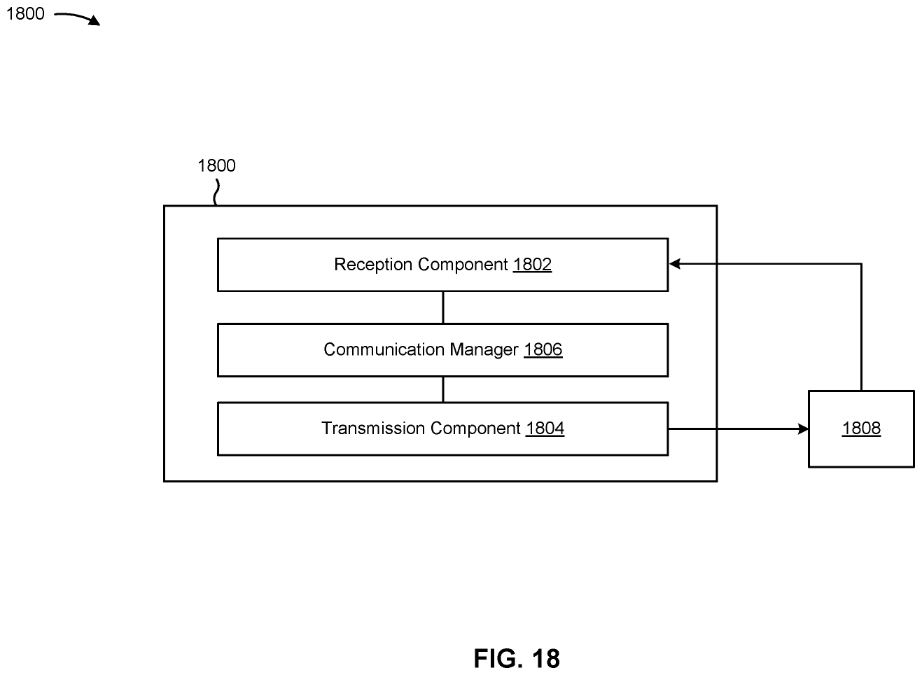

As shown in FIG. 16, in some aspects, process 1600 may include receiving an adaptation indication that includes one or more of: a spatial adaptation indication that indicates one or more derived resources associated with a first CSI-RS base resource, each derived resource including a subset of CSI-RS ports of a network entity that are derived from the first CSI-RS base resource, or a power adaptation indication that indicates one or more power offsets for the first CSI-RS base resource or for the one or more derived resources (block 1610). For example, the UE (e.g., using reception component 1802 and/or communication manager 1806, depicted in FIG. 18) may receive an adaptation indication that includes one or more of: a spatial adaptation indication that indicates one or more derived resources associated with a first CSI-RS base resource, each derived resource including a subset of CSI-RS ports of a network entity that are derived from the first CSI-RS base resource, or a power adaptation indication that indicates one or more power offsets for the first CSI-RS base resource or for the one or more derived resources, as described above.

As shown in FIG. 16, in some aspects, process 1600 may include transmitting CSI feedback based at least in part on one or more of measurement of a CSI-RS from the one or more derived resources, measurement of the CSI-RS in association with the one or more power offsets, or measurement of a base CSI-RS transmitted from the first CSI-RS base resource in association with the one or more power offsets (block 1620). For example, the UE (e.g., using transmission component 1804 and/or communication manager 1806, depicted in FIG. 18) may transmit CSI feedback based at least in part on one or more of measurement of a CSI-RS from the one or more derived resources, measurement of the CSI-RS in association with the one or more power offsets, or measurement of a base CSI-RS transmitted from the first CSI-RS base resource in association with the one or more power offsets, as described above.

Process 1600 may include additional aspects, such as any single aspect or any combination of aspects described below and/or in connection with one or more other processes described elsewhere herein.

In a first aspect, the adaptation indication indicates one or more adaptation sets that each include one or more adaptation items, and an adaptation item may include a derived resource or a virtual power offset.

In a second aspect, alone or in combination with the first aspect, the adaptation indication indicates, for each adaptation item in an adaptation set, an associated CSI-RS base resource.

In a third aspect, alone or in combination with one or more of the first and second aspects, the adaptation indication further indicates, for each adaptation item in the adaptation set, one or more parameters.

In a fourth aspect, alone or in combination with one or more of the first through third aspects, the one or more parameters include parameters in a codebook configuration that characterize a size of an antenna subarray associated with the derived resource.

In a fifth aspect, alone or in combination with one or more of the first through fourth aspects, the one or more parameters include one or more spatial adaptation parameters that indicate a subset of CSI-RS ports, from CSI-RS ports of the CSI-RS base resource, that are for channel measurements of the derived resource.

In a sixth aspect, alone or in combination with one or more of the first through fifth aspects, the one or more parameters include parameters in a codebook configuration for calculation of a PMI for the derived resource.

In a seventh aspect, alone or in combination with one or more of the first through sixth aspects, the one or more parameters include a power adaptation parameter that is associated with CSI calculation and that indicates a power offset between a PDSCH and the derived resource.

In an eighth aspect, alone or in combination with one or more of the first through seventh aspects, the one or more parameters include a power adaptation parameter that is associated with CSI calculation and that indicates a power offset between the derived resource and an SSS.

In a ninth aspect, alone or in combination with one or more of the first through eighth aspects, process 1600 includes generating the CSI feedback for an adaptation item in an adaptation set based at least in part on one or more parameters associated with the adaptation item and in-use parameters of the associated CSI-RS base resource that are not overridden by the adaptation indication.

In a tenth aspect, alone or in combination with one or more of the first through ninth aspects, the adaptation indication includes one or more adaptation items associated with one or more other CSI-RS base resources, and the one or more other CSI-RS base resources have a same quantity of ports as the first CSI-RS base resource and are included in a first base resource set that includes the first CSI-RS base resource.

In an eleventh aspect, alone or in combination with one or more of the first through tenth aspects, process 1600 includes one or more of receiving an indication of a quantity of adaptation items selected for CSI feedback, transmitting, with the CSI feedback, an indication of selected adaptation items in a first adaptation set that are selected for the CSI feedback, or selecting adaptation items for the CSI feedback based at least in part on one or more of a measured signal quality or an indicated cost factor of each adaptation item in the first adaptation set.

In a twelfth aspect, alone or in combination with one or more of the first through eleventh aspects, the one or more derived resources are included in a first adaptation set and are associated with CSI-RS base resources in a first base resource set, and a subset of adaptation items in the first adaptation set are associated with a base resource in the first base resource set.

In a thirteenth aspect, alone or in combination with one or more of the first through twelfth aspects, the spatial adaptation indication includes a first CSI-RS report configuration.

In a fourteenth aspect, alone or in combination with one or more of the first through thirteenth aspects, the first CSI-RS report configuration indicates a first adaptation set with at least one derived resource, where each derived resource in the first adaptation set has a first quantity of CSI-RS ports that is less than a quantity of CSI-RS ports of the first CSI-RS base resource, and the first adaptation set is associated with the first CSI-RS base resource.

In a fifteenth aspect, alone or in combination with one or more of the first through fourteenth aspects, the adaptation set includes multiple derived resources having a same quantity of CSI-RS ports, and each derived resource of the multiple derived resources has a different starting CSI-RS port.

In a sixteenth aspect, alone or in combination with one or more of the first through fifteenth aspects, the at least one derived resource in the first adaptation set share a same codebook configuration.

In a seventeenth aspect, alone or in combination with one or more of the first through sixteenth aspects, a subset of the at least one derived resource in the first adaptation set that are associated with the first CSI-RS base resource share a same codebook configuration.

In an eighteenth aspect, alone or in combination with one or more of the first through seventeenth aspects, the spatial adaptation indication indicates a second adaptation set with at least one derived resource where each derived resource has a second quantity of CSI-RS ports that is less than the first quantity of CSI-RS ports, and the second adaptation set is associated with the first CSI-RS base resource or a first base resource set that includes the first CSI-RS base resource.

In a nineteenth aspect, alone or in combination with one or more of the first through eighteenth aspects, the spatial adaptation indication indicates a second adaptation set with at least one derived resource where each derived resource has a second quantity of CSI-RS ports that is less than the first quantity of CSI-RS ports, and the second adaptation set is associated with a second CSI-RS base resource or a second base resource set.

In a twentieth aspect, alone or in combination with one or more of the first through nineteenth aspects, a quantity of derived resources in the first adaptation set is limited based at least in part on a maximum quantity of CSI-RS ports of the derived resources in the first adaptation set.

In a twenty-first aspect, alone or in combination with one or more of the first through twentieth aspects, transmitting the CSI feedback includes transmitting CSI feedback for each adaptation set of at least one adaptation item as indicated in the adaptation indication.

In a twenty-second aspect, alone or in combination with one or more of the first through twenty-first aspects, process 1600 includes receiving another adaptation indication that indicates one or more other adaptation sets, where transmitting the CSI feedback includes transmitting CSI feedback for each adaptation set of the one or more other adaptation sets.

In a twenty-third aspect, alone or in combination with one or more of the first through twenty-second aspects, receiving the adaptation indication includes receiving the adaptation indication in one or more of a CSI measurement configuration, a CSI report configuration, a CSI resource configuration, a CSI non-zero power CSI-RS resource set message, a semi-persistent CSI trigger state message, an aperiodic CSI trigger state message, or a CSI associated report configuration information.

In a twenty-fourth aspect, alone or in combination with one or more of the first through twenty-third aspects, process 1600 includes transmitting a capability indication that indicates a maximum quantity of CSIs corresponding to spatial adaptation patterns that can be included in a single CSI report of CSI feedback.

In a twenty-fifth aspect, alone or in combination with one or more of the first through twenty-fourth aspects, process 1600 includes transmitting a capability indication that indicates a maximum quantity of CSIs corresponding to power offset values that can be included in a single CSI report of CSI feedback.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram illustrating an example process 1700 performed, for example, by a network entity, in accordance with the present disclosure. Example process 1700 is an example where the network entity (e.g., network node 110, network entity 1510) performs operations associated with indication of derived resources or a power control offset.

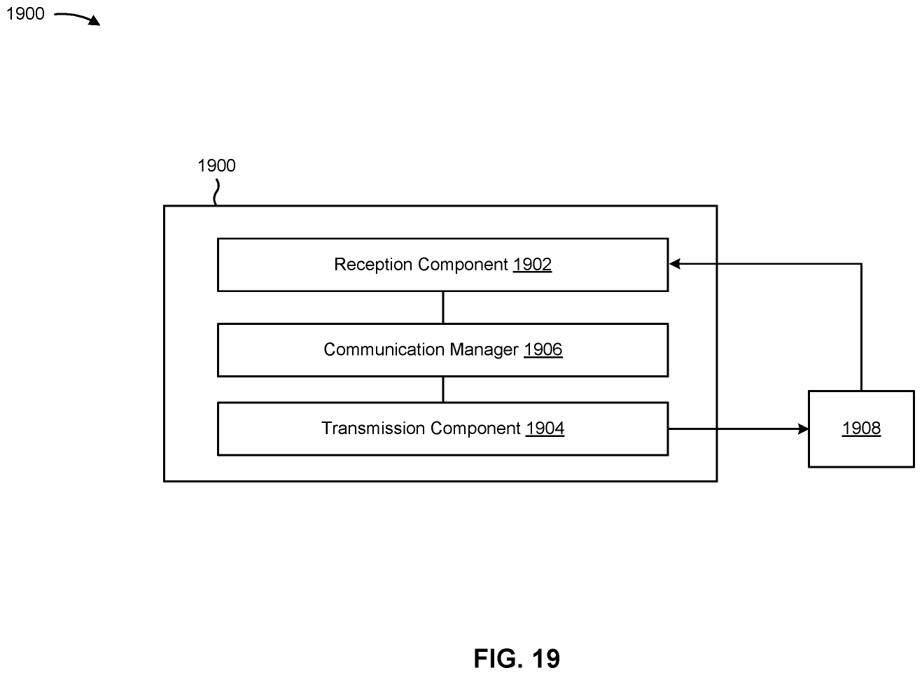

As shown in FIG. 17, in some aspects, process 1700 may include generating an adaptation indication that includes one or more of: a spatial adaptation indication that indicates one or more derived resources associated with a first CSI-RS base resource, each derived resource including a subset of CSI-RS ports of a network entity that are derived from the first CSI-RS base resource, or a power adaptation indication that indicates one or more power offsets for the first CSI-RS base resource or for the one or more derived resources (block 1710). For example, the network entity (e.g., using communication manager 1906, depicted in FIG. 19) may generate an adaptation indication that includes one or more of: a spatial adaptation indication that indicates one or more derived resources associated with a first CSI-RS base resource, each derived resource including a subset of CSI-RS ports of a network entity that are derived from the first CSI-RS base resource, or a power adaptation indication that indicates one or more power offsets for the first CSI-RS base resource or for the one or more derived resources, as described above.

As further shown in FIG. 17, in some aspects, process 1700 may include transmitting the adaptation indication (block 1720). For example, the network entity (e.g., using transmission component 1904 and/or communication manager 1906, depicted in FIG. 19) may transmit the adaptation indication, as described above.

Process 1700 may include additional aspects, such as any single aspect or any combination of aspects described below and/or in connection with one or more other processes described elsewhere herein.

In a first aspect, the spatial adaptation indication includes a first CSI-RS report configuration. In a second aspect, alone or in combination with the first aspect, the spatial adaptation indication includes a triggering state indication. In some aspects, the adaptation indication indicates one or more adaptation sets that each include one or more adaptation items, and an adaptation item may include a derived resource or a virtual power offset. In some aspects, the adaptation indication indicates, for each adaptation item in an adaptation set, an associated CSI-RS base resource. In some aspects, the adaptation indication further indicates, for each adaptation item in the adaptation set, one or more parameters.

In a third aspect, alone or in combination with one or more of the first and second aspects, process 1700 includes receiving a capability indication that indicates a capability of a user equipment (UE) to use multiple derived resources or a capability of the UE to use a power control offset for the first CSI-RS base resource.

In a fourth aspect, alone or in combination with one or more of the first through third aspects, the one or more parameters include parameters in a codebook configuration that characterize a size of an antenna subarray associated with the derived resource.

In a fifth aspect, alone or in combination with one or more of the first through fourth aspects, the one or more parameters include one or more spatial adaptation parameters that indicate a subset of CSI-RS ports, from CSI-RS ports of the CSI-RS base resource, that are for channel measurements of the derived resource.

In a sixth aspect, alone or in combination with one or more of the first through fifth aspects, the one or more parameters include parameters in a codebook configuration for calculation of a PMI for the derived resource.

In a seventh aspect, alone or in combination with one or more of the first through sixth aspects, the one or more parameters include a power adaptation parameter that is associated with CSI calculation and that indicates a power offset between a PDSCH and the derived resource.

In an eighth aspect, alone or in combination with one or more of the first through seventh aspects, the one or more parameters include a power adaptation parameter that is associated with CSI calculation and that indicates a power offset between the derived resource and an SSS.

In a ninth aspect, alone or in combination with one or more of the first through eighth aspects, the adaptation indication includes one or more adaptation items associated with one or more other CSI-RS base resources, and the one or more other CSI-RS base resources have a same quantity of ports as the first CSI-RS base resource and are included in a first base resource set that includes the first CSI-RS base resource.

In a tenth aspect, alone or in combination with one or more of the first through ninth aspects, the one or more derived resources are included in a first adaptation set and are associated with CSI-RS base resources in a first base resource set, and a subset of adaptation items in the first adaptation set are associated with a base resource in the first base resource set.

In an eleventh aspect, alone or in combination with one or more of the first through tenth aspects, the spatial adaptation indication includes a first CSI-RS report configuration.

In a twelfth aspect, alone or in combination with one or more of the first through eleventh aspects, the first CSI-RS report configuration indicates a first adaptation set with at least one derived resource, where each derived resource in the first adaptation set has a first quantity of CSI-RS ports that is less than a quantity of CSI-RS ports of the first CSI-RS base resource, and the first adaptation set is associated with the first CSI-RS base resource.

In a thirteenth aspect, alone or in combination with one or more of the first through twelfth aspects, the adaptation set includes multiple derived resources having a same quantity of CSI-RS ports, and each derived resource of the multiple derived resources has a different starting CSI-RS port.

In a fourteenth aspect, alone or in combination with one or more of the first through thirteenth aspects, the at least one derived resource in the first adaptation set share a same codebook configuration.

In a fifteenth aspect, alone or in combination with one or more of the first through fourteenth aspects, a subset of the at least one derived resource in the first adaptation set that are associated with the first CSI-RS base resource share a same codebook configuration.

In a sixteenth aspect, alone or in combination with one or more of the first through fifteenth aspects, the spatial adaptation indication indicates a second adaptation set with at least one derived resource where each derived resource has a second quantity of CSI-RS ports that is less than the first quantity of CSI-RS ports, and the second adaptation set is associated with the first CSI-RS base resource or a first base resource set that includes the first CSI-RS base resource.

In a seventeenth aspect, alone or in combination with one or more of the first through sixteenth aspects, In a nineteenth aspect, alone or in combination with one or more of the first through eighteenth aspects, the spatial adaptation indication indicates a second adaptation set with at least one derived resource where each derived resource has a second quantity of CSI-RS ports that is less than the first quantity of CSI-RS ports, and the second adaptation set is associated with a second CSI-RS base resource or a second base resource set.

In a seventeenth aspect, alone or in combination with one or more of the first through sixteenth aspects, a quantity of derived resources in the first adaptation set is limited based at least in part on a maximum quantity of CSI-RS ports of the derived resources in the first adaptation set.

In an eighteenth aspect, alone or in combination with one or more of the first through seventeenth aspects, process 1700 includes transmitting another adaptation indication that indicates one or more other adaptation sets, where receiving the CSI feedback includes receiving CSI feedback for each adaptation set of the one or more other adaptation sets.

In a nineteenth aspect, alone or in combination with one or more of the first through nineteenth aspects, transmitting the adaptation indication includes transmitting the adaptation indication in one or more of a CSI measurement configuration, a CSI report configuration, a CSI resource configuration, a CSI non-zero power CSI-RS resource set message, a semi-persistent CSI trigger state message, an aperiodic CSI trigger state message, or a CSI associated report configuration information.

In a twentieth aspect, alone or in combination with one or more of the first through nineteenth aspects, process 1700 includes receiving a capability indication that indicates a maximum quantity of CSIs corresponding to spatial adaptation patterns that can be included in a single CSI report of CSI feedback.

In a twenty-first aspect, alone or in combination with one or more of the first through twentieth aspects, process 1700 includes receiving a capability indication that indicates a maximum quantity of CSIs corresponding to power offset values that can be included in a single CSI report of CSI feedback.

Although FIG. 17 shows example blocks of process 1700, in some aspects, process 1700 may include additional blocks, fewer blocks, different blocks, or differently arranged blocks than those depicted in FIG. 17. Additionally, or alternatively, two or more of the blocks of process 1700 may be performed in parallel.

FIG. 18 is a diagram of an example apparatus 1800 for wireless communication, in accordance with the present disclosure. The apparatus 1800 may be a UE (e.g., UE 120, UE 1520), or a UE may include the apparatus 1800. In some aspects, the apparatus 1800 includes a reception component 1802, a transmission component 1804, and/or a communication manager 1806, which may be in communication with one another (for example, via one or more buses and/or one or more other components). In some aspects, the communication manager 1806 is the communication manager 140 described in connection with FIG. 1. As shown, the apparatus 1800 may communicate with another apparatus 1808, such as a UE or a network node (such as a CU, a DU, an RU, or a base station), using the reception component 1802 and the transmission component 1804.

In some aspects, the apparatus 1800 may be configured to perform one or more operations described herein in connection with FIGS. 1-15. Additionally, or alternatively, the apparatus 1800 may be configured to perform one or more processes described herein, such as process 1600 of FIG. 16. In some aspects, the apparatus 1800 and/or one or more components shown in FIG. 18 may include one or more components of the UE described in connection with FIG. 2. Additionally, or alternatively, one or more components shown in FIG. 18 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1802 may receive communications, such as reference signals, control information, data communications, or a combination thereof, from the apparatus 1808. The reception component 1802 may provide received communications to one or more other components of the apparatus 1800. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1800. In some aspects, the reception component 1802 may include one or more antennas, a modem, a demodulator, a MIMO detector, a receive processor, a controller/processor, a memory, or a combination thereof, of the UE described in connection with FIG. 2.

The transmission component 1804 may transmit communications, such as reference signals, control information, data communications, or a combination thereof, to the apparatus 1808. In some aspects, one or more other components of the apparatus 1800 may generate communications and may provide the generated communications to the transmission component 1804 for transmission to the apparatus 1808. In some aspects, the transmission component 1804 may perform signal processing on the generated communications (such as filtering, amplification, modulation, digital-to-analog conversion, multiplexing, interleaving, mapping, or encoding, among other examples), and may transmit the processed signals to the apparatus 1808. In some aspects, the transmission component 1804 may include one or more antennas, a modem, a modulator, a transmit MIMO processor, a transmit processor, a controller/processor, a memory, or a combination thereof, of the UE described in connection with FIG. 2. In some aspects, the transmission component 1804 may be co-located with the reception component 1802 in a transceiver.

The communication manager 1806 may support operations of the reception component 1802 and/or the transmission component 1804. For example, the communication manager 1806 may receive information associated with configuring reception of communications by the reception component 1802 and/or transmission of communications by the transmission component 1804. Additionally, or alternatively, the communication manager 1806 may generate and/or provide control information to the reception component 1802 and/or the transmission component 1804 to control reception and/or transmission of communications.

The reception component 1802 may receive an adaptation indication that includes one or more of: a spatial adaptation indication that indicates one or more derived resources associated with a first CSI-RS base resource, each derived resource including a subset of CSI-RS ports of a network entity that are derived from the first CSI-RS base resource, or a power adaptation indication that indicates one or more power offsets for the first CSI-RS base resource or for the one or more derived resources. The transmission component 1804 may transmit CSI feedback based at least in part on one or more of measurement of a CSI-RS from the one or more derived resources, measurement of the CSI-RS in association with the one or more power offsets, or measurement of a base CSI-RS transmitted from the first CSI-RS base resource in association with the one or more power offsets.

The communication manager 1806 may generate the CSI feedback for an adaptation item in an adaptation set based at least in part on one or more parameters associated with the adaptation item and in-use parameters of the associated CSI-RS base resource that are not overridden by the adaptation indication.

The reception component 1802 may receive another adaptation indication that indicates one or more other adaptation sets, and the transmission component 1804 may transmit the CSI feedback for each adaptation set of the one or more other adaptation sets.

The transmission component 1804 may transmit a capability indication that indicates a maximum quantity of CSIs corresponding to spatial adaptation patterns that can be included in a single CSI report of CSI feedback.

The transmission component 1804 may transmit a capability indication that indicates a maximum quantity of CSIs corresponding to power offset values that can be included in a single CSI report of CSI feedback.

The reception component 1802 may receive another adaptation indication that indicates one or more other adaptation sets, and the transmission component 1804 may transmit CSI feedback for each adaptation set of the one or more other adaptation sets.

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

FIG. 19 is a diagram of an example apparatus 1900 for wireless communication, in accordance with the present disclosure. The apparatus 1900 may be a network entity (e.g., network node 110, network entity 1510), or a network entity may include the apparatus 1900. In some aspects, the apparatus 1900 includes a reception component 1902, a transmission component 1904, and/or a communication manager 1906, which may be in communication with one another (for example, via one or more buses and/or one or more other components). In some aspects, the communication manager 1906 is the communication manager 150 described in connection with FIG. 1. As shown, the apparatus 1900 may communicate with another apparatus 1908, such as a UE or a network node (such as a CU, a DU, an RU, or a base station), using the reception component 1902 and the transmission component 1904.

In some aspects, the apparatus 1900 may be configured to perform one or more operations described herein in connection with FIGS. 1-15. Additionally, or alternatively, the apparatus 1900 may be configured to perform one or more processes described herein, such as process 1700 of FIG. 17. In some aspects, the apparatus 1900 and/or one or more components shown in FIG. 19 may include one or more components of the network entity described in connection with FIG. 2. Additionally, or alternatively, one or more components shown in FIG. 19 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1902 may receive communications, such as reference signals, control information, data communications, or a combination thereof, from the apparatus 1908. The reception component 1902 may provide received communications to one or more other components of the apparatus 1900. In some aspects, the reception component 1902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1900. In some aspects, the reception component 1902 may include one or more antennas, a modem, a demodulator, a MIMO detector, a receive processor, a controller/processor, a memory, or a combination thereof, of the network entity described in connection with FIG. 2.

The transmission component 1904 may transmit communications, such as reference signals, control information, data communications, or a combination thereof, to the apparatus 1908. In some aspects, one or more other components of the apparatus 1900 may generate communications and may provide the generated communications to the transmission component 1904 for transmission to the apparatus 1908. In some aspects, the transmission component 1904 may perform signal processing on the generated communications (such as filtering, amplification, modulation, digital-to-analog conversion, multiplexing, interleaving, mapping, or encoding, among other examples), and may transmit the processed signals to the apparatus 1908. In some aspects, the transmission component 1904 may include one or more antennas, a modem, a modulator, a transmit MIMO processor, a transmit processor, a controller/processor, a memory, or a combination thereof, of the network entity described in connection with FIG. 2. In some aspects, the transmission component 1904 may be co-located with the reception component 1902 in a transceiver.

The communication manager 1906 may support operations of the reception component 1902 and/or the transmission component 1904. For example, the communication manager 1906 may receive information associated with configuring reception of communications by the reception component 1902 and/or transmission of communications by the transmission component 1904. Additionally, or alternatively, the communication manager 1906 may generate and/or provide control information to the reception component 1902 and/or the transmission component 1904 to control reception and/or transmission of communications.

The communication manager 1906 may generate an adaptation indication that includes one or more of a spatial adaptation indication that indicates one or more derived resources associated with a first CSI-RS base resource, each derived resource including a subset of CSI-RS ports of a network entity that are derived from the first CSI-RS base resource, or a power adaptation indication that indicates a power adaptation indication that indicates one or more power offsets for the first CSI-RS base resource or for the one or more derived resources. The transmission component 1904 may transmit the adaptation indication.

The reception component 1802 may receive a capability indication that indicates a maximum quantity of CSIs corresponding to spatial adaptation patterns that can be included in a single CSI report of CSI feedback.

The reception component 1802 may receive a capability indication that indicates a maximum quantity of CSIs corresponding to power offset values that can be included in a single CSI report of CSI feedback.

The transmission component 1804 may transmit another adaptation indication that indicates one or more other adaptation sets, and the reception component 1802 may receive CSI feedback for each adaptation set of the one or more other adaptation sets.

The number and arrangement of components shown in FIG. 19 are provided as an example. In practice, there may be additional components, fewer components, different components, or differently arranged components than those shown in FIG. 19. Furthermore, two or more components shown in FIG. 19 may be implemented within a single component, or a single component shown in FIG. 19 may be implemented as multiple, distributed components. Additionally, or alternatively, a set of (one or more) components shown in FIG. 19 may perform one or more functions described as being performed by another set of components shown in FIG. 19.

The following provides an overview of some Aspects of the present disclosure:
Aspect 1: A method of wireless communication performed by a user equipment (UE), comprising: receiving an adaptation indication that includes one or more of: a spatial adaptation indication that indicates one or more derived resources associated with a first CSI-RS base resource, each derived resource including a subset of channel state information (CSI) reference signal (CSI-RS) ports of a network entity that are derived from the first CSI-RS base resource, or a power adaptation indication that indicates one or more power offsets for the first CSI-RS base resource or for the one or more derived resources; and transmitting CSI feedback based at least in part on one or more of measurement of a CSI-RS from the one or more derived resources, measurement of the CSI-RS in association with the one or more power offsets, or measurement of a base CSI-RS transmitted from the first CSI-RS base resource in association with the one or more power offsets.
Aspect 2: The method of Aspect 1, wherein the adaptation indication indicates one or more adaptation sets that each include one or more adaptation items, and wherein an adaptation item may include a derived resource or a virtual power offset.
Aspect 3: The method of Aspect 2, wherein the adaptation indication indicates, for each adaptation item in an adaptation set, an associated CSI-RS base resource.
Aspect 4: The method of Aspect 3, wherein the adaptation indication further indicates, for each adaptation item in the adaptation set, one or more parameters.
Aspect 5: The method of Aspect 4, wherein the one or more parameters include parameters in a codebook configuration that characterize a size of an antenna subarray associated with the derived resource.
Aspect 6: The method of Aspect 4, wherein the one or more parameters include one or more spatial adaptation parameters that indicate a subset of CSI-RS ports, from CSI-RS ports of the CSI-RS base resource, that are for channel measurements of the derived resource.
Aspect 7: The method of Aspect 4, wherein the one or more parameters include parameters in a codebook configuration for calculation of a precoding matrix indicator (PMI) for the derived resource.
Aspect 8: The method of Aspect 4, wherein the one or more parameters include a power adaptation parameter that is associated with CSI calculation and that indicates a power offset between a physical downlink shared channel (PDSCH) and the derived resource.
Aspect 9: The method of Aspect 4, wherein the one or more parameters include a power adaptation parameter that is associated with CSI calculation and that indicates a power offset between the derived resource and a secondary synchronization signal (SSS).
Aspect 10: The method of Aspect 4, further comprising generating the CSI feedback for an adaptation item in an adaptation set based at least in part on one or more parameters associated with the adaptation item and in-use parameters of the associated CSI-RS base resource that are not overridden by the adaptation indication.
Aspect 11: The method of Aspect 2, wherein a reported CSI resource index for a spatial adaptation or a power adaptation refers to an index of a selected adaptation item in an adaptation set.
Aspect 12: The method of Aspect 2, wherein a first subset of derived resources in a first adaptation set is associated with a first CSI-RS base resource in a first resource base set, and wherein a second subset of derived resources in a second adaptation set is associated with a second CSI-RS base resource in the first base resource set.
Aspect 13: The method of Aspect 2, wherein the adaptation indication is a first adaptation indication, and wherein the one or more processors are individually or collectively configured to transmit CSI feedback for a subset of adaption sets indicated by a second adaptation indication.
Aspect 14: The method of any of Aspects 1-13, wherein the adaptation indication includes one or more adaptation items associated with one or more other CSI-RS base resources, and wherein the one or more other CSI-RS base resources have a same quantity of ports as the first CSI-RS base resource and are included in a first base resource set that includes the first CSI-RS base resource.
Aspect 15: The method of any of Aspects 1-14, further comprising one or more of: receiving an indication of a quantity of adaptation items selected for CSI feedback; transmitting, with the CSI feedback, an indication of selected adaptation items in a first adaptation set that are selected for the CSI feedback; or selecting adaptation items for the CSI feedback based at least in part on one or more of a measured signal quality or an indicated cost factor of each adaptation item in the first adaptation set.
Aspect 16: The method of any of Aspects 1-15, wherein the one or more derived resources are included in a first adaptation set and are associated with CSI-RS base resources in a first base resource set, and wherein a subset of adaptation items in the first adaptation set are associated with a base resource in the first base resource set.
Aspect 17: The method of any of Aspects 1-16, wherein the spatial adaptation indication includes a first CSI-RS report configuration.
Aspect 18: The method of Aspect 17, wherein the first CSI-RS report configuration indicates a first adaptation set with at least one derived resource, where each derived resource in the first adaptation set has a first quantity of CSI-RS ports that is less than a quantity of CSI-RS ports of the first CSI-RS base resource, and wherein the first adaptation set is associated with the first CSI-RS base resource.
Aspect 19: The method of Aspect 18, wherein the adaptation set includes multiple derived resources having a same quantity of CSI-RS ports, and wherein each derived resource of the multiple derived resources has a different starting CSI-RS port.
Aspect 20: The method of Aspect 18, wherein the at least one derived resource in the first adaptation set share a same codebook configuration.
Aspect 21: The method of Aspect 18, wherein a subset of the at least one derived resource in the first adaptation set that are associated with the first CSI-RS base resource share a same codebook configuration.
Aspect 22: The method of Aspect 18, wherein the spatial adaptation indication indicates a second adaptation set with at least one derived resource where each derived resource has a second quantity of CSI-RS ports that is less than the first quantity of CSI-RS ports, and wherein the second adaptation set is associated with the first CSI-RS base resource or a first base resource set that includes the first CSI-RS base resource.
Aspect 23: The method of Aspect 18, wherein the spatial adaptation indication indicates a second adaptation set with at least one derived resource where each derived resource has a second quantity of CSI-RS ports that is less than the first quantity of CSI-RS ports, and wherein the second adaptation set is associated with a second CSI-RS base resource or a second base resource set.
Aspect 24: The method of Aspect 18, wherein a quantity of derived resources in the first adaptation set is limited based at least in part on a maximum quantity of CSI-RS ports of the derived resources in the first adaptation set.
Aspect 25: The method of any of Aspects 1-24, wherein transmitting the CSI feedback includes transmitting CSI feedback for each adaptation set of at least one adaptation item as indicated in the adaptation indication.
Aspect 26: The method of any of Aspects 1-25, further comprising receiving another adaptation indication that indicates one or more other adaptation sets, wherein transmitting the CSI feedback includes transmitting CSI feedback for each adaptation set of the one or more other adaptation sets.
Aspect 27: The method of any of Aspects 1-26, wherein receiving the adaptation indication includes receiving the adaptation indication in one or more of a CSI measurement configuration, a CSI report configuration, a CSI resource configuration, a CSI non-zero power CSI-RS resource set message, a semi-persistent CSI trigger state message, an aperiodic CSI trigger state message, or a CSI associated report configuration information.
Aspect 28: The method of any of Aspects 1-27, further comprising transmitting a capability indication that indicates a maximum quantity of CSIs corresponding to spatial adaptation patterns that can be included in a single CSI report of CSI feedback.
Aspect 29: The method of any of Aspects 1-28, further comprising transmitting a capability indication that indicates a maximum quantity of CSIs corresponding to power offset values that can be included in a single CSI report of CSI feedback.
Aspect 30: A method of wireless communication performed by a network entity, comprising: generating an adaptation indication that includes one or more of: a spatial adaptation indication that indicates one or more derived resources associated with a first CSI-RS base resource, each derived resource including a subset of channel state information (CSI) reference signal (CSI-RS) ports of a network entity that are derived from the first CSI-RS base resource, or a power adaptation indication that indicates one or more power offsets for the first CSI-RS base resource or for the one or more derived resources; and transmitting the adaptation indication.
Aspect 31: The method of Aspect 30, wherein the spatial adaptation indication includes a first CSI-RS report configuration.
Aspect 32: The method of any of Aspects 30-31, wherein the spatial adaptation indication includes a triggering state indication.
Aspect 33: The method of any of Aspects 30-32, further comprising receiving a capability indication that indicates a capability of a user equipment (UE) to use multiple derived resources or a capability of the UE to use a power control offset for the first CSI-RS base resource.
Aspect 34: An apparatus for wireless communication at a device, comprising a processor; memory coupled with the processor; and instructions stored in the memory and executable by the processor to cause the apparatus to perform the method of one or more of Aspects 1-33.
Aspect 35: A device for wireless communication, comprising a memory and one or more processors coupled to the memory, the one or more processors configured to perform the method of one or more of Aspects 1-33.
Aspect 36: An apparatus for wireless communication, comprising at least one means for performing the method of one or more of Aspects 1-33.
Aspect 37: A non-transitory computer-readable medium storing code for wireless communication, the code comprising instructions executable by a processor to perform the method of one or more of Aspects 1-33.
Aspect 38: A non-transitory computer-readable medium storing a set of instructions for wireless communication, the set of instructions comprising one or more instructions that, when executed by one or more processors of a device, cause the device to perform the method of one or more of Aspects 1-33.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, individually or collectively configured to:
receive an adaptation indication that includes one or more of:
a spatial adaptation indication that indicates one or more derived resources associated with a first CSI-RS base resource, each derived resource including a subset of channel state information (CSI) reference signal (CSI-RS) ports of a network entity that are derived from the first CSI-RS base resource, or
a power adaptation indication that indicates one or more power offsets for the first CSI-RS base resource or for the one or more derived resources; and
transmit CSI feedback based at least in part on one or more of measurement of a CSI-RS from the one or more derived resources, measurement of the CSI-RS in association with the one or more power offsets, or measurement of a base CSI-RS transmitted from the first CSI-RS base resource in association with the one or more power offsets.

2. The UE of claim 1, wherein the adaptation indication indicates one or more adaptation sets that each include one or more adaptation items, and wherein an adaptation item may include a derived resource or a virtual power offset.

3. The UE of claim 2, wherein the adaptation indication indicates, for each adaptation item in an adaptation set, an associated CSI-RS base resource.

4. The UE of claim 3, wherein the adaptation indication further indicates, for each adaptation item in the adaptation set, one or more parameters.

5. The UE of claim 4, wherein the one or more parameters include parameters in a codebook configuration that characterize a size of an antenna subarray associated with the derived resource.

6. The UE of claim 4, wherein the one or more parameters include one or more spatial adaptation parameters that indicate a subset of CSI-RS ports, from CSI-RS ports of the CSI-RS base resource, that are for channel measurements of the derived resource.

7. The UE of claim 4, wherein the one or more parameters include parameters in a codebook configuration for calculation of a precoding matrix indicator (PMI) for the derived resource.

8. The UE of claim 4, wherein the one or more parameters include a power adaptation parameter that is associated with CSI calculation and that indicates a power offset between a physical downlink shared channel (PDSCH) and the derived resource.

9. The UE of claim 4, wherein the one or more parameters include a power adaptation parameter that is associated with CSI calculation and that indicates a power offset between the derived resource and a secondary synchronization signal (SSS).

10. The UE of claim 4, wherein the one or more processors are individually or collectively configured to generate the CSI feedback for an adaptation item in an adaptation set based at least in part on one or more parameters associated with the adaptation item and in-use parameters of the associated CSI-RS base resource that are not overridden by the adaptation indication.

11. The UE of claim 2, where a reported CSI resource index for a spatial adaptation or a power adaptation refers to an index of a selected adaptation item in an adaptation set.

12. The UE of claim 2, wherein a first subset of derived resources in a first adaptation set is associated with a first CSI-RS base resource in a first resource base set, and wherein a second subset of derived resources in a second adaptation set is associated with a second CSI-RS base resource in the first base resource set.

13. The UE of claim 2, wherein the adaptation indication is a first adaptation indication, and wherein the one or more processors are individually or collectively configured to transmit CSI feedback for a subset of adaption sets indicated by a second adaptation indication.

14. The UE of claim 1, wherein the adaptation indication includes one or more adaptation items associated with one or more other CSI-RS base resources, and wherein the one or more other CSI-RS base resources have a same quantity of ports as the first CSI-RS base resource and are included in a first base resource set that includes the first CSI-RS base resource.

15. The UE of claim 1, wherein the one or more processors are individually or collectively configured to one or more of:
receive an indication of a quantity of adaptation items selected for CSI feedback;
transmit, with the CSI feedback, an indication of selected adaptation items in a first adaptation set that are selected for the CSI feedback; or
select adaptation items for the CSI feedback based at least in part on one or more of a measured signal quality or an indicated cost factor of each adaptation item in the first adaptation set.

16. The UE of claim 1, wherein the one or more derived resources are included in a first adaptation set and are associated with CSI-RS base resources in a first base resource set, and wherein a subset of adaptation items in the first adaptation set are associated with a base resource in the first base resource set.

17. The UE of claim 1, wherein the spatial adaptation indication includes a first CSI-RS report configuration.

18. The UE of claim 17, wherein the first CSI-RS report configuration indicates a first adaptation set with at least one derived resource, wherein each derived resource in the first adaptation set has a first quantity of CSI-RS ports that is less than a quantity of CSI-RS ports of the first CSI-RS base resource, and wherein the first adaptation set is associated with the first CSI-RS base resource.

19. The UE of claim 18, wherein the adaptation set includes multiple derived resources having a same quantity of CSI-RS ports, and wherein each derived resource of the multiple derived resources has a different starting CSI-RS port.

20. The UE of claim 18, wherein the at least one derived resource in the first adaptation set share a same codebook configuration.

21. The UE of claim 18, wherein a subset of the at least one derived resource in the first adaptation set that are associated with the first CSI-RS base resource share a same codebook configuration.

22. The UE of claim 18, wherein the spatial adaptation indication indicates a second adaptation set with at least one derived resource, wherein each derived resource has a second quantity of CSI-RS ports that is less than the first quantity of CSI-RS ports, and wherein the second adaptation set is associated with the first CSI-RS base resource or a first base resource set that includes the first CSI-RS base resource.

23. The UE of claim 18, wherein the spatial adaptation indication indicates a second adaptation set with at least one derived resource, wherein each derived resource has a second quantity of CSI-RS ports that is less than the first quantity of CSI-RS ports, and wherein the second adaptation set is associated with a second CSI-RS base resource or a second base resource set.

24. The UE of claim 1, wherein the one or more processors, to transmit the CSI feedback, are individually or collectively configured to transmit CSI feedback for each adaptation set of at least one adaptation item as indicated in the adaptation indication.

25. The UE of claim 1, wherein the one or more processors are individually or collectively configured to receive another adaptation indication that indicates one or more other adaptation sets, and wherein to transmit the CSI feedback, the one or more processors are individually or collectively configured to transmit CSI feedback for each adaptation set of the one or more other adaptation sets.

26. The UE of claim 1, wherein the one or more processors, to receive the adaptation indication, are individually or collectively configured to receive the adaptation indication in one or more of a CSI measurement configuration, a CSI report configuration, a CSI resource configuration, a CSI non-zero power CSI-RS resource set message, a semi-persistent CSI trigger state message, an aperiodic CSI trigger state message, or a CSI associated report configuration information.

27. The UE of claim 1, wherein the one or more processors are individually or collectively configured to transmit a capability indication that indicates a maximum quantity of CSIs corresponding to spatial adaptation patterns or power offset values that can be included in a single CSI report of CSI feedback.

28. A network entity for wireless communication, comprising:
one or more memories; and
one or more processors, coupled to the one or more memories, individually or collectively configured to:
generate an adaptation indication that includes one or more of:
a spatial adaptation indication that indicates one or more derived resources associated with a first CSI-RS base resource, each derived resource including a subset of channel state information (CSI) reference signal (CSI-RS) ports of a network entity that are derived from the first CSI-RS base resource, or
a power adaptation indication that indicates one or more power offsets for the first CSI-RS base resource or for the one or more derived resources; and
transmit the adaptation indication.

29. The network entity of claim 28, wherein the spatial adaptation indication includes a first CSI-RS report configuration.

30. The network entity of claim 28, wherein the spatial adaptation indication includes a triggering state indication.
